(19) United States
(12) Patent Application Publication
(10) Pub. No.: US 2012/0229494 A1
(43) Pub. Date: Sep. 13, 2012

(54) DISPLAY DEVICE AND METHOD OF CONTROLLING DISPLAY

(76) Inventors: Takahiro Kobayashi, Okayama (JP); Yoshio Umeda, Hyogo (JP)

(21) Appl. No.: 13/413,004

(22) Filed: Mar. 6, 2012

(30) Foreign Application Priority Data
Mar. 8, 2011 (JP) 2011-050642

(51) Int. Cl. G09G 3/36; G09G 5/10

(52) U.S. Cl. 345/589; 345/208; 345/204; 345/89

(57) ABSTRACT

A display device including: a liquid crystal panel having liquid crystals driven to display a frame image; a generator which generates image data to display the frame image in response to a frame image signal corresponding to the frame image; a driver which writes the image data to the liquid crystal panel to drive the liquid crystals; and a detector for detecting a temperature of the driver, wherein the generator adjusts how many times the image data are written to the liquid crystal panel by the driver in response to the temperature of the driver.

### BACKGROUND OF THE INVENTION

1. Field of the Invention

The present invention relates to a display device on which video images are displayed, and a method for controlling display.

2. Description of Background Art

A display device on which stereoscopic video images are displayed alternately displays a left frame image, which is viewed by the left eye (hereinafter, referred to as “L frame image”) and a right frame image, which is viewed by the right eye (hereinafter, referred to as “R frame image”) at a predetermined cycle (e.g., field cycle). The displayed L and R frame images are different in contents from each other by an amount of parallax. A viewer views the L and R frame images through an eyeglass device which has liquid crystal shutters driven in synchronization with the display frequency of the L and R frame images (c.f., JP 2009-25436 A). As a result, the viewer stereoscopically perceives an object rendered in the L and R frame images.

It is necessary that image data of these frame images are written in a short period of time, for example, in order to alternately display the L and R frame images so that the viewer stereoscopically perceives the video image. Because of the short writing period for the image data, a display device with a liquid crystal panel often encounters problems of insufficient charge to the liquid crystals and delayed response of the liquid crystals.

The present inventors have figured out that the aforementioned problems may be solved by writing image data multiple times to display one frame image.

FIG. 34 is a schematic timing chart showing a number of writing operations for a single frame image. The number of writing operations is described with reference to FIG. 34.

The section (a) in FIG. 34 shows a period assigned for displaying R and L frame images. As shown in the section (a) in FIG. 34, typically, the periods for displaying the R and L frame images are alternately defined in order to stereoscopically display video images.

In the period for displaying the R frame image, image data corresponding to the R frame image are written. In the period for displaying the L frame image, image data corresponding to the L frame image are written.

The section (b) in FIG. 34 schematically shows a writing operation performed by a display device of the present inventor. As shown in the section (b) in FIG. 34, the display device of the present inventor performs a first writing operation and a second writing operation in a period for displaying a single frame image.

The first writing operation begins from an upper region of a liquid crystal panel. After the image data are written to a lower region of the liquid crystal panel, the second writing operation is initiated. The second writing operation begins from the upper region of the liquid crystal panel, like the first writing operation. After the image data are written to the lower region, a period for displaying the subsequent frame image is started. In the period for displaying the subsequent frame image, the first and second writing operations are performed.

The liquid crystals are driven in frame inversion mode. In the section (b) in FIG. 34, the liquid crystals are driven with a positive polarity (“+”) by the first and second writing operations corresponding to the R frame image. The liquid crystals are driven with a negative polarity (“−”) by the first and second writing operations corresponding to the L frame image.

The charge to the liquid crystal reaches a target value in the second writing operation under the frame inversion mode shown in the section (b) in FIG. 34 even if the liquid crystals are insufficiently charged in the first writing operation.

If only the first writing operation is performed, the short writing period for the image data potentially causes the insufficient charge to the liquid crystals even when the R and L frame images have the same gradation value. For example, if the R and L frame images are entirely white images (without taking account of the parallax between the R and L frame images), for example, a drive voltage is switched from “−10 V” to “+10 V” in order to switch from the R frame image to the L frame image. The liquid crystals may be insufficiently charged because of a large fluctuation of the drive voltage only within the period for the first writing operation, so that the image data are written without achieving a target level of the potential. Thus, the L frame image has a region that is displayed at a hue other than “white”. On the other hand, if the second writing operation is performed after the first writing operation, the insufficient writing of the image data in the first writing operation may be compensated by the second writing operation.

The section (c) in FIG. 34 schematically shows timings at which liquid crystal shutters of an eyeglass device open. As shown in the section (c) in FIG. 34, the liquid crystal shutters of the eyeglass device open at the ends of the display periods for the R and L frame images, respectively.

In the display device of the present inventor, the first writing operation is performed in a relatively short period of time in order to ensure the period for the second writing operation. Therefore, it happens relatively early timing to drive the liquid crystals in the lower region of the liquid crystal panel, which results in less interference (crosstalk) between the R and L frame images in the lower region of the liquid crystal panel.

If the frame image is displayed only in the first writing operation, the first writing operation typically has to take a long time in order to solve the aforementioned insufficient writing. Thus, response of the liquid crystals particularly in the lower region of the liquid crystal panel is delayed, which results in noticeable crosstalk in the lower region of the liquid crystal panel.

As described above, the display device of the present inventor performs the first and second writing operations in the period for rendering a single frame image to appropriately solve the insufficient writing of the image data and crosstalk. However, the increase in frequency of the writing operation of the image data heats up a driving device, which drives the liquid crystals, and deteriorate performance of the driving device (e.g., fluctuation in midpoint potential). For example, the change in the midpoint potential may potentially cause insufficient writing of the image data and burn-in of the liquid crystal panel. The temperature rise may also make the driving device less reliable.

### SUMMARY OF THE INVENTION

An object of the present invention is to provide a display device and a method for controlling display, which may solve the resultant deterioration of displayed images from the heat generation in an element configured to drive liquid crystal.

A display device according to one aspect of the present invention has: a liquid crystal panel including liquid crystals which are driven to display a frame image; a generator which generates image data to display the frame image in response to a frame image signal corresponding to the frame image; a driver which writes the image data to the liquid crystal panel to drive the liquid crystal; and a detector which detects a temperature of the driver, wherein the generator adjusts how many times the image data are written to the liquid crystal panel by the driver in response to the temperature of the driver.

A method for controlling display according to one aspect of the present invention has the steps of: measuring a temperature of a driver which writes image data to a liquid crystal panel to drive liquid crystals; determining how many times the image data are written, in response to the temperature of the driver; and writing the image data by the determined number of times to display a frame image on the liquid crystal panel.

As described above, the display device and the method for controlling display according to the present invention may solve the resultant deterioration of displayed images from the heat generation in the element which drives the liquid crystals.

Other objects, features and advantages of the present invention will be more apparent from the following detailed description taken in conjunction with the accompanying drawings.

### BRIEF DESCRIPTION OF THE DRAWINGS

FIG. 1 is a schematic block diagram showing a video system including a display device according to the first embodiment;

FIG. 2 is a schematic view of the video system shown in FIG. 1;

FIG. 3 is a schematic block diagram of a video signal processor in the display device shown in FIG. 1;

FIG. 4 is a schematic chart showing a luminance level which is varied by gamma correction performed by a gamma adjuster of the video signal processor shown in FIG. 3;

FIG. 5 is a schematic view showing a part of a liquid crystal panel of the display device shown in FIG. 1;

FIG. 6 is a schematic view showing an operation to write image data performed by a driver of the display device shown in FIG. 1;

FIG. 7 is a flow chart schematically showing a method for controlling display, which is carried out if a detector in the display device shown in FIG. 1 detects a higher temperature of the driver than a first temperature threshold value;

FIG. 8 is a conceptual view of luminance adjustment for first image data, which is performed by the display device shown in FIG. 1;

FIG. 9 is a conceptual view of luminance adjustment for second image data in step S100 of the flow chart shown in FIG. 7;

FIG. 10 is a schematic timing chart showing an operation of a video system 100 in the step S100 of the flow chart shown in FIG. 7;

FIG. 11 is a conceptual view of luminance adjustment for second image data in step S120 of the flow chart shown in FIG. 7;

FIG. 12 is a schematic timing chart showing an operation of the video system in the step S120 of the flow chart shown in FIG. 7;

FIG. 13 is a schematic timing chart showing an operation of the video system in the steps S120 to S150 of the flow chart shown in FIG. 7;

FIG. 14 is a flow chart schematically showing a method for controlling display, which is carried out if the detector in the display device shown in FIG. 1 detects a lower temperature of the driver than a second temperature threshold value;

FIG. 15 is a schematic block diagram showing a video system comprising a display device according to the second embodiment;

FIG. 16 is a schematic block diagram of a video signal processor in the display device shown in FIG. 15;

FIG. 17 is a schematic view showing output characteristics of a gamma adjuster of the video signal processor shown in FIG. 16;

FIG. 18 is a schematic block diagram showing a video system comprising a display device according to the third embodiment;

FIG. 19 is a schematic block diagram of a video signal processor of the display device shown in FIG. 18;

FIG. 20 is a schematic timing chart showing an operation of the video system in step S100 of the flow chart shown in FIG. 7;

FIG. 21 is a schematic timing chart showing an operation of the video system in step S150 of the flow chart shown in FIG. 7;

FIG. 22 is a schematic chart showing a change in luminance associated with execution of the step S120 of the flow chart shown in FIG. 7;

FIG. 23 is a schematic block diagram showing a video system comprising a display device according to the fourth embodiment;

FIG. 24 is a schematic block diagram of a video signal processor of the display device shown in FIG. 23;

FIG. 25 is a schematic view showing a part of a liquid crystal panel of the display device shown in FIG. 23;

FIG. 26 shows a change in luminance of pixels defined by an average operation, which is exemplified as an equalization operation performed by an equalizer of the video signal processor shown in FIG. 24;

FIG. 27 is a schematic view showing a part of a liquid crystal panel of the display device shown in FIG. 23;

FIG. 28 shows a change in luminance of pixels defined by a selecting operation, which is exemplified as an equalization operation performed by the equalizer of the video signal processor shown in FIG. 24;

FIG. 29A is a schematic graph showing a writing operation performed by a driver of the display device shown in FIG. 23;

FIG. 29B is a schematic graph showing a writing operation performed by the driver of the display device shown in FIG. 23;

FIG. 30 is a flow chart schematically showing a method for controlling display, which is carried out if a detector of the display device shown in FIG. 23 detects a higher temperature of the driver than a first temperature threshold value;

FIG. 31 is a schematic timing chart showing an operation of the video system in step S300 of the flow chart shown in FIG. 30;

FIG. 32 is a schematic timing chart showing an operation of the video system in step S320 of the flow chart shown in FIG. 30;

FIG. 33 is a schematic timing chart showing an operation of the video system in steps S350 to S355 of the flow chart shown in FIG. 30; and

FIG. 34 is a schematic timing chart showing a number of writing operations for a single frame image.

### DESCRIPTION OF THE PREFERRED EMBODIMENTS

A display device and a display control method according to various embodiments are described with reference to the accompanying drawings. It should be noted that similar components and parts are depicted by the same reference numerals in the following embodiments. Redundant descriptions are omitted as appropriate for the purpose of clarification. Configurations, arrangements or shapes shown in the drawings as well as descriptions associated with the drawings are merely for the purpose of making principles of the embodiments easily understood. Therefore, the principles of the display device and the video image controlling method are not limited thereto.

### First Embodiment

### (Configuration of Video System)

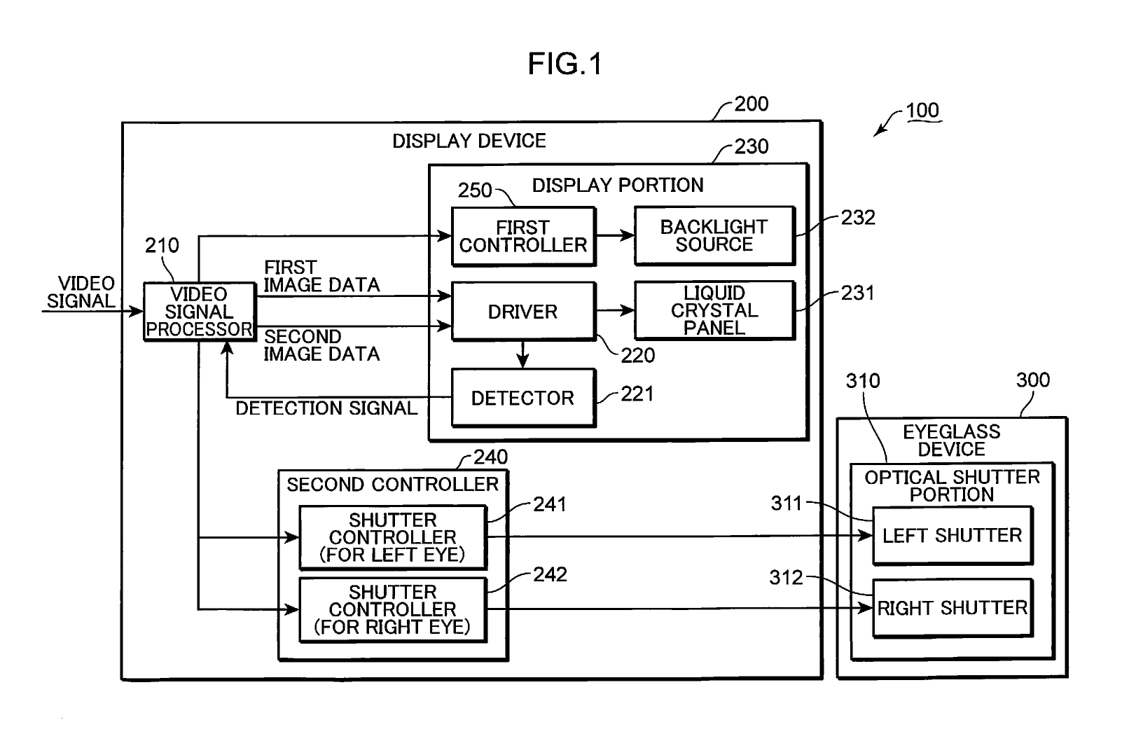

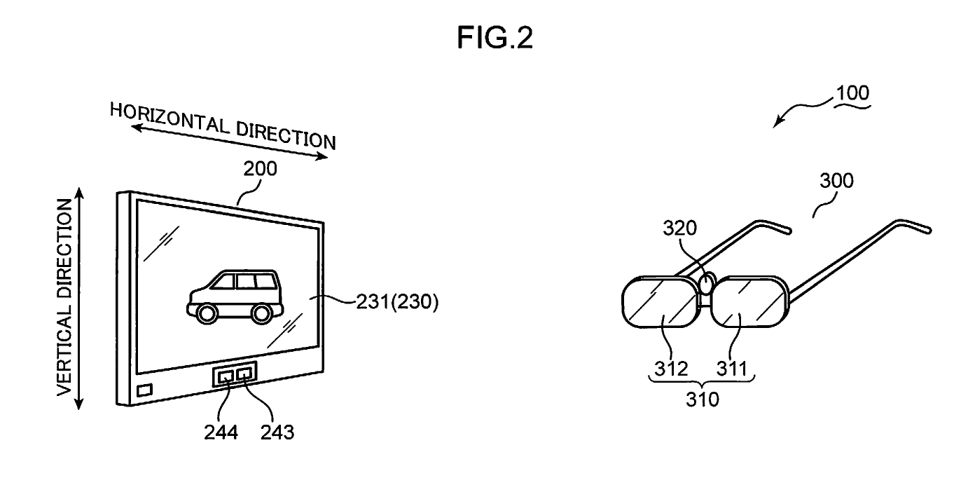

FIG. 1 is a schematic block diagram showing a configuration of a video system including a display device according to the first embodiment. FIG. 2 is a schematic view of the video system shown in FIG. 1. The schematic configuration of the video system is described with reference to FIGS. 1 and 2.

The video system 100 includes a display device 200 and an eyeglass device 300. The display device 200 displays frame images including a left frame image, which is viewed by the left eye (hereinafter, referred to as “L frame image”), and a right frame image, which is viewed by the right eye (hereinafter, referred to as “R frame image”). The eyeglass device 300 helps viewing the L and R frame images, which are displayed on the display device 200. The eyeglass device 300 performs a stereoscopic view assistance in synchronization with the display of the L and R frame images by the display device 200 so that a viewer views the L and R frame images with the left and right eyes, respectively. As a result, the viewer stereoscopically perceives the frame images (the L and R frame images) displayed on the display device 200 through the eyeglass device 300 (the viewer perceives an object, which is rendered in the L and R frame images, as if the object came out from or into a display surface on which the L and R frame images are displayed).

The eyeglass device 300, which looks like eyeglasses for vision correction, comprises an optical shutter portion 310 having a left shutter 311 and a right shutter 312. The left and right shutters 311, 312 are situated in front of the left and right eyes of the viewer, respectively. The left shutter 311 opens if the L frame image is displayed on the display device 200. The left shutter 311 closes if the R frame image is displayed on the display device 200. The right shutter 312 closes if the L frame image is displayed on the display device 200. The right shutter 312 opens if the R frame image is displayed on the display device 200. While the L frame image is displayed on the display device 200, the left shutter 311 allows light from the L frame image to travels to the left eye of the viewer and the right shutter 312 blocks the light from the L frame image to the right eye of the viewer. Thus, the L frame image is viewed only by the left eye of the viewer. Likewise, while the R frame image is displayed on the display device 200, the right shutter 312 allows light from the R frame image to travel to the right eye of the viewer and the left shutter 311 blocks the light from the R frame image to the left eye of the viewer. Thus, the R frame image is viewed only by the right eye of the viewer. The left shutter 311 is exemplified as the left filter in this embodiment. The right shutter 312 is exemplified as the right filter. Other optical elements which adjust a light amount directed from video images displayed on the display device 200 to the left eye of the viewer (hereinafter, referred to as “left light amount”) and a light amount directed to the right eye of the viewer (hereinafter, referred to as an “right light amount”) may be used as the left and right filters. For example, deflection elements (e.g., a liquid crystal filter), which deflect the light directed to the left and right eyes of the viewer, and other optical elements, which adjust the light amount, are suitably used as the left and right filters. The left filter is controlled so that the left light amount is increased in synchronization with the display of the L frame image and decreased in synchronization with the display of the R frame image. Likewise, the right filter is controlled so that the right light amount is increased in synchronization with the display of the R frame image and decreased in synchronization with the L frame image.

The display device 200 comprises a video signal processor 210, which processes video signals and a display portion 230, on which video images are displayed.

The video signal processor 210 receives video signals (a video signal for the left eye (referred to as “L signal” hereinafter) and a video signal for the right eye (referred to as “R signal” hereinafter) which have a vertical synchronization frequency as a control base. The video signal processor 210 alternatively outputs the received L and R signals at a frequency which is K times (K is a natural number) as high as the vertical synchronization frequency. The inputted video signals at 60 Hz are converted into L and R signals at 120 Hz in this embodiment. The converted L and R signals are output to the display portion 230 as the image data. In this embodiment, the image data includes first image data and second image data. It is described below how to write the first and second image data. The display portion 230 uses the first and second image data to display one frame image. Instead, the video signal processor 210 may output N-th image data (N is a natural number which is no less than 3) in addition to the first and second image data, in response to how many times the image data are written. The display portion may use the first to N-th image data to display one frame image.

The display portion 230 has a liquid crystal panel 231 and a backlight source 232. The liquid crystal panel 231 includes liquid crystals which are driven to display frame images. The backlight source 232 emits light toward the liquid crystal panel 231. The display portion 230 further includes a driver 220 and a detector 221. The driver 220 drives the liquid crystals to write the image data to the liquid crystal panel 231. The detector 221 detects a temperature of the driver 220.

The detector 221 measures the temperature of the driver 220 to send a detection signal, which includes information about the measured temperature, to the video signal processor 210. The video signal processor 210 switches output modes of the image data between a first output mode and a second output mode in response to the temperature of the driver 220. The first output mode is used for outputting both the first and second image data. The second output mode is used for outputting only the first image data.

If the video signal processor 210 outputs both of the first and second image data (first output mode), the driver 220 writes the first image data to the liquid crystal panel 231. The driver 220 writes the second image data to the liquid crystal panel 231 following the first image data. Therefore, the driver 220 performs two writing operations to display a single frame image while the video signal processor 210 outputs the image data under the first output mode. In the following descriptions, an operation to write the first image data by the driver 220 (an operation of the driver 220 driving liquid crystals of the liquid crystal panel 231 in response to the first image data) is exemplified as “first writing operation”. An operation to write the second image data by the driver 220 (an operation of the driver 220 driving liquid crystals of the liquid crystal panel 231 in response to the second image data) is exemplified as “second writing operation”.

If the video signal processor 210 outputs only the first image data (second output mode), the driver 220 writes the first image data to the liquid crystal panel 231. Therefore, a frame image corresponding to the first image data is displayed on the liquid crystal panel 231. The video signal processor 210 then outputs the first image data corresponding to the subsequent frame image. The driver 220 writes the subsequent first image data to the liquid crystal panel 231. Therefore, the subsequent frame image corresponding to the first image data is displayed on the liquid crystal panel 231.

As described above, the video signal processor 210 switches the first and second output modes in response to the temperature of the driver 220 to adjust how many times the image data are written to the liquid crystal panel 231 by the driver 220. In this embodiment, the video signal processor 210 is exemplified as the generator. The switching operation of the output mode and the generation of the image data in response to the temperature of the driver 220 are described later. It should be noted that if the video signal processor generates the first to N-th image data (N is a natural number which is no less than 3), the video signal processor may switch three or more output modes to adjust how many times the image data are written.

The display portion 230 further includes a first controller 250 configured to control the backlight source 232. The video signal processor 210 sends control signals to the first controller 250 in synchronization with the output of the L and R signals. The first controller 250 controls the backlight source 232 of the display portion 230 in response to the control signal sent from the video signal processor 210.

The display device 200 further includes a second controller 240 which controls the eyeglass device 300. The video signal processor 210 outputs control signals to control the second controller 240 in synchronization with the output of the L and R signals. The second controller 240 controls the optical shutter portion 310 in response to the control signal sent from the video signal processor 210. The control signal sent to the first and/or second controllers 250, 240 may be the L and/or R signals itself/themselves after the conversion by the video signal processor 210. Alternatively, the control signal sent to the first and/or second controllers 250, 240 may be vertical synchronization signals of the L and/or R signals at 120 Hz.

The video signal with video information between one vertical synchronization signal in the L signal and the subsequent vertical synchronization signal which follows the one vertical synchronization signal is referred to as “L frame image signal” hereafter. The video signal including video information between one vertical synchronization signal in the R signal and the subsequent vertical synchronization signal which follows the one vertical synchronization signal is referred to as “R frame image signal” in the following descriptions. The L frame image signal is used to display the L frame image. Likewise, the R frame image signal is used to display the R frame image. The L and/or R frame image signals is/are exemplified as the frame image signal or signals in this embodiment.

The video signal processor 210 processes the L frame image signal to generate L image data and display the L frame image. If the video signal processor 210 operates under the first output mode, the L image data are sent to the driver 220 as the first and second image data. In this embodiment, a luminance level of the L image data output as the second image data is differentiated from a luminance level of the L image data, which are output as the first image data, under a relatively high temperature of the driver 220.

The video signal processor 210 processes the R frame image signal to generate an R image data and display the R frame image. If the video signal processor 210 operates under the first output mode, the R image data are sent to the driver 220 as the first and second image data. A luminance level of the R image data output as the second image data is differentiated from a luminance level of the R image data, which are output as the first image data, under a relatively high temperature of the driver 220 in this embodiment. It is described below how to determine the difference in the luminance level between the first and second image data.

The video signal processor 210 generates the L and R image data in response to the received L and R signals, respectively. The video signal processor 210 alternately sends the L and R image data to the driver 220. The driver 220 alternately writes the L and R image data to the liquid crystal panel 231 in response to the output from the video signal processor 210. As a result, the liquid crystal panel 231 alternately displays the L and R frame images. The backlight source 232 illuminates the liquid crystal panel 231 in response to the control signal sent from the video signal processor 210. The driver 220 writes a frame image signal (the L image data or the R image data) in vertical and horizontal directions to drive the liquid crystals of the liquid crystal panel 231.

The driver 220 converts the first and second image data into a display format of the liquid crystal panel 231 in response to the vertical and horizontal synchronization signals which are included in the input signal (the first and/or second image data) sent from the video signal processor 210. The first and second image data, which are converted for every frame image display, are written to the liquid crystal panel 231 by the driver 220.

The driver 220 performs gamma correction on the first and second image data to convert the first and second image data into the display format of the liquid crystal panel 231 in this embodiment. The video signal processor 210 performs another gamma correction on the frame image signal under the relatively high temperature of the driver 220, in addition to signal processes using the gamma correction by the driver 220, in order to determine the difference in the luminance level between the first and second image data. The signal processes with the gamma correction by the video signal processor 210 and the driver 220 are described below.

The liquid crystals are driven by the aforementioned driver 220, so that the liquid crystal panel 231 modulates light, which is transmitted from the back, in response to the received first and/or second image data. Thus, the liquid crystal panel 231 alternately displays the L and R frame images. For example, the liquid crystal panel 231 may be a suitable display system such as an IPS (In Plane Switching), VA (Vertical Alignment) or TN (Twisted Nematic) type panel.

The backlight source 232 emits light which travels from the back of the liquid crystal panel 231 to the display surface of the liquid crystal panel 231. A two dimensional array of light emitting diodes (LED) (not shown) is used as the backlight source 232 to achieve the surface mode emission in this embodiment. Alternatively, fluorescent tubes, which are arranged to achieve the surface emission, may be used as the backlight source 232. The diodes and fluorescent tubes used as the backlight source 232 may be arranged along the edge of the liquid crystal panel 231 for the surface emission (edge type).

The first controller 250 outputs light emission control signals in response to the control signals at 120 Hz sent from the video signal processor 210. The backlight source 232 may blink in response to the light emission control signal.

The second controller 240 controls the optical shutter portion 310 of the eyeglass device 300 in synchronism with the display cycle of the L and R frame images. The second controller 240 has a shutter controller 241 for the left eye (referred to as “L shutter controller 241” hereinafter), which controls the left shutter 311 and a shutter controller 242 for the right eye (referred to as “R shutter controller 242” hereinafter), which controls the right shutter 312. For example, the L shutter controller 241 controls the eyeglass device 300 so that the left shutter 311 adjusts (increases and decreases) the left light amount at 60 Hz if the liquid crystal panel 231 alternately displays the L and R frame images at 120 Hz. Likewise, the R shutter controller 242 controls the eyeglass device 300 so that the right shutter 312 adjusts (increases and decreases) the right light amount at 60 Hz.

As shown in FIG. 2, in this embodiment, the display device 200 comprises a first transmitter 243 and a second transmitter 244. The first transmitter 243 sends a first synchronization signal in synchronization with the display of the L frame image. The second transmitter 244 sends a second synchronization signal in synchronization with the display of the R frame image. The eyeglass device 300 has a receiver 320 situated between the left and right shutters 311, 312. The receiver 320 receives the first and second synchronization signals. Preferably, the first synchronization signal is different in waveform from the second synchronization signal. The receiver 320 distinguishes the first synchronization signal from the second synchronization signal on the basis of the waveform of the received synchronization signal. Thus, the eyeglass device 300 operates the left shutter 311 in response to the first synchronization signal. The eyeglass device 300 operates the right shutter 312 in response to the second synchronization signal. Known other communication or signal processing technologies may be used for wireless communication of the synchronization signal between the display device 200 and the eyeglass device 300 as well as internal processes of the synchronization signal (the first and second synchronization signals) by the eyeglass device 300. Alternatively, communication of the synchronization signal (the first and second synchronization signals) between the display device and the eyeglass device may be wired communication. A single transmitter may be integrated with the display device which combines the first transmitter which transmits the first synchronization signal in synchronization with the display of the L frame image with the second transmitter which transmits the second synchronization signal in synchronization with the display of the R frame image. In this case, the alternate display of the L and R frame images may be synchronized with rising edges of common synchronization signals.

The L and R shutter controllers 241, 242 determine phases of increasing and decreasing the left and right light amounts for the left and right shutters 311, 312, respectively, on the basis of the control signal sent from the video signal processor 210. The L and R shutter controllers 241, 242 output the first and second synchronization signals, respectively, in response to the determined phase. The left and right shutters 311, 312 increase and decrease the left and right light amounts in synchronism with the display of the L and R frame images in response to the first and second synchronization signals, respectively.

The second controller 240 determines how long the left and right light amounts are increased by the left and right shutters 311, 312, respectively (referred to as “light increase period” hereinafter) and timing (phase) of the light increase period, in consideration with a crosstalk (interference) between the displayed L and R frame images as well as response characteristics of the liquid crystal panel 231. The L shutter controller 241 controls the length and timing of the light increase period for the left light amount. The R shutter controller 242 controls the length and timing of the light increase period for the right light amount.

The first controller 250, which is operated in response to the control signal at 120 Hz of the video signal processor 210, outputs the light emission control signal to emit the backlight source 232 in synchronization with the operation to adjust the light amount by the left and right shutters 311, 312. The backlight source 232 may blink in response to the light emission control signal. It should be noted that, in this embodiment, the backlight source 232 is always lit under the control of the first controller 250. Thus, the timing and length in which the viewer may view the frame image is determined by the operation of the optical shutter portion 310 of the eyeglass device 300.

Alternatively, the first controller may turn on the backlight source during a part of the light increase period adjusted by the second controller or a period generally corresponding to the light increase period, and turn off the backlight source in the other period. The timing and length of a viewing period, during which the viewer may view the frame image, are determined by the blinking operation of the backlight source under such blinking control for the backlight source by the first controller.

### (Video Signal Processor)

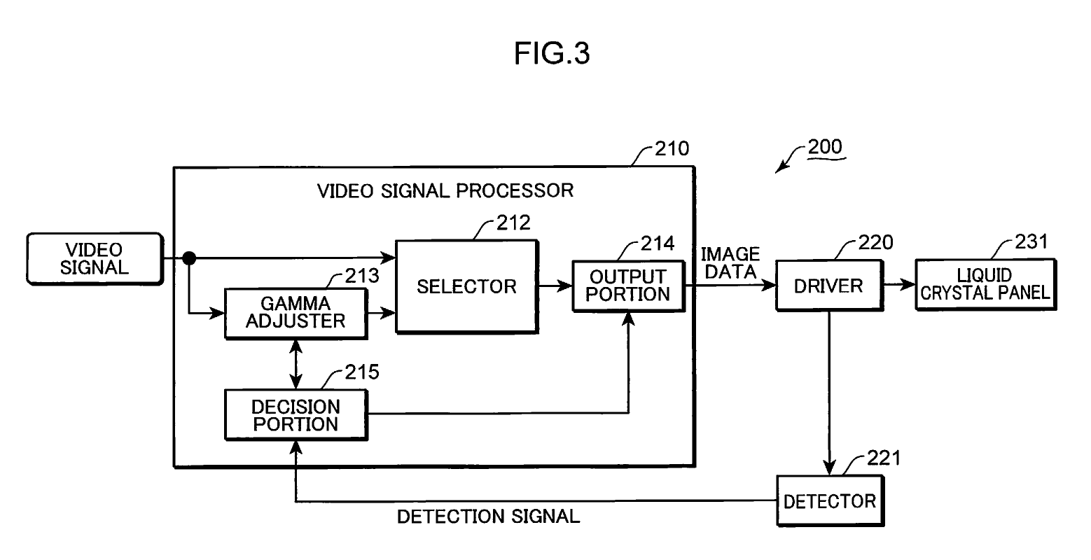

FIG. 3 is a schematic block diagram showing a functional configuration of the video signal processor 210 of the display device 200 according to this embodiment. The video signal processor 210 is described with reference to FIGS. 1 and 3.

The video signal processor 210 has a selector 212, a gamma adjuster 213, an output portion 214 and a decision portion 215.

The video signals (L and R signals) are sent to the selector 212 and the gamma adjuster 213. As aforementioned, the detector 221 measures the temperature of the driver 220. The detector 221 then sends the detection signal including information about the detected temperature to the decision portion 215. The decision portion 215 stores data of a first temperature threshold value defined for the temperature of the driver 220. The decision portion 215 sends the control signal to the gamma adjuster 213, so that the gamma adjuster 213 performs the gamma correction of the video signal if the detection signal indicates a higher temperature than the first temperature threshold value. If the control signal sent from the decision portion 215 instructs the execution of the gamma correction, the gamma adjuster 213 performs the gamma correction on the video signal. Unless the decision portion 215 outputs the control signal or unless the control signal sent from the decision portion 215 instructs the execution of the gamma correction, the gamma adjuster 213 sends the received video signal to the selector 212. In this embodiment, the first temperature threshold value stored in the decision portion 215 is exemplified as the first threshold value.

The video signal directly sent to the selector 212 is further output from the selector 212 to the output portion 214 in a period assigned for writing the first image data. In a period assigned for writing the second image data, the video signal received from the gamma adjuster 213 is sent from the selector 212 to the output portion 214.

The video signal, which the output portion 214 receives from the selector 212, is output to the driver 220 as the first image data in the period assigned for writing the first image data. The video signal, which the output portion 214 receives from the selector 212, is output to the driver 220 as the second image data in the period assigned for writing the second image data.

In the period assigned for writing the first image data, the driver 220 writes the first image data to the liquid crystal panel 231. In the period assigned for writing the second image data, the driver 220 writes the second image data to the liquid crystal panel 231.

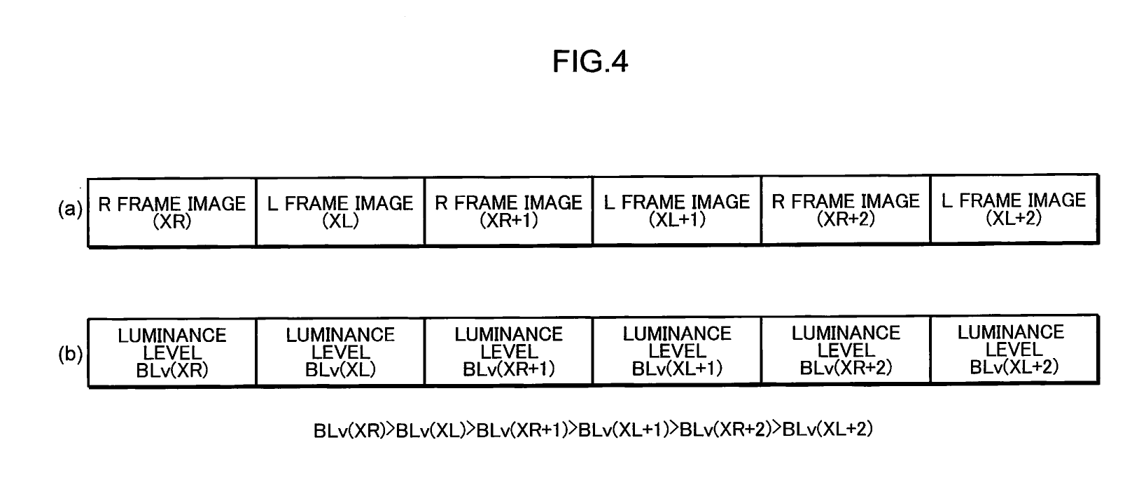

FIG. 4 is a schematic chart showing luminance levels which are varied by the gamma correction which the gamma adjuster 213 performs. The video signal processor 210 is further described with reference to FIGS. 1, 3 and 4.

The X-th displayed R frame image (R frame image (XR)), the X-th displayed L frame image (L frame image (XL)), the (X+1)-th displayed R frame image (R frame image (XR+1)), the (X+1)-th displayed L frame image (L frame image (XL+1)), the (X+2)-th displayed R frame image (R frame image (XR+2)), and the (X+2)-th displayed L frame image (L frame image (XL+2)) are shown in the section (a) in FIG. 4. The R frame image (XR), the L frame image (XL), the R frame image (XR+1), the L frame image (XL+1), the R frame image (XR+2) and the L frame image (XL+2) are sequentially displayed on the liquid crystal panel 231. In this embodiment, the R frame image (XR) is exemplified as the first frame image. The L frame image (XL), the R frame image (XR+1), the L frame image (XL+1), the R frame image (XR+2) or the L frame image (XL+2) displayed after the R frame image (XR) is exemplified as the second frame image.

The gamma adjuster 213 performs the gamma correction for each frame image signal defined by the vertical synchronization signal included in the video signal to adjust the luminance level of each frame image. As a result, the second image data, of which luminance level is adjusted, is generated. The gamma adjuster 213 is exemplified as the luminance adjuster in this embodiment.

The luminance level BLv(XR) of the R frame image (XR), the luminance level BLv(XL) of the L frame image (XL), the luminance level BLv(XR+1) of the R frame image (XR+1), the luminance level BLv(XL+1) of the L frame image (XL+1), the luminance level BLv(XR+2) of the R frame image (XR+2), and the luminance level BLv(XL+2) of the L frame image (XL+2) are shown in the section (b) in FIG. 4. The inequality shown in FIG. 4 represents a relationship among the luminance levels.

As shown by the inequality in FIG. 4, the gamma adjuster 213 performs the gamma correction so that the later the frame image is displayed, the lower the luminance level thereof is. If the gamma adjuster 213 defines a higher luminance level, the liquid crystal panel 231 displays a brighter frame image. If the gamma adjuster 213 defines a lower luminance level, the liquid crystal panel 231 displays a darker frame image. Thus, the liquid crystal panel 231 displays video images which gradually become darker once the gamma adjuster 213 begins the gamma correction. The luminance level BLv(XR) of the R frame image (XR) is exemplified as the first luminance level in this embodiment. The luminance level BLv(XL) of the L frame image (XL), the luminance level BLv(XR+1) of the R frame image (XR+1), the luminance level BLv(XL+1) of the L frame image (XL+1), the luminance level BLv(XR+2) of the R frame image (XR+2), and the luminance level BLv(XL+2) of the L frame image (XL+2) are exemplified as the second luminance levels.

As shown in FIG. 3, the gamma adjuster 213 begins the gamma correction operation to output a video signal having a lower luminance level if the temperature of the driver 220 exceeds the first temperature threshold value. On the other hand, the video signal directly sent to the selector 212 is not subjected to the signal processes to reduce the luminance level. Thus, if the temperature of the driver 220 exceeds the first temperature threshold value, the luminance level defined for the first image data becomes larger than the luminance level defined for the second image data.

A notification signal to transmit information about the luminance level defined by the gamma adjuster 213 is sent from the gamma adjuster 213 to the decision portion 215 at the same time of outputting the video signal subjected to the gamma correction (output to the selector 212) as shown in FIG. 3. The decision portion 215 stores data about a target luminance defined for the luminance level. The decision portion 215 compares the information about the luminance level included in the notification signal to the data about the target luminance. A control signal to stop outputting the second image data is sent from the decision portion 215 to the output portion 214 if the luminance level notified by the notification signal is lower than the target luminance.

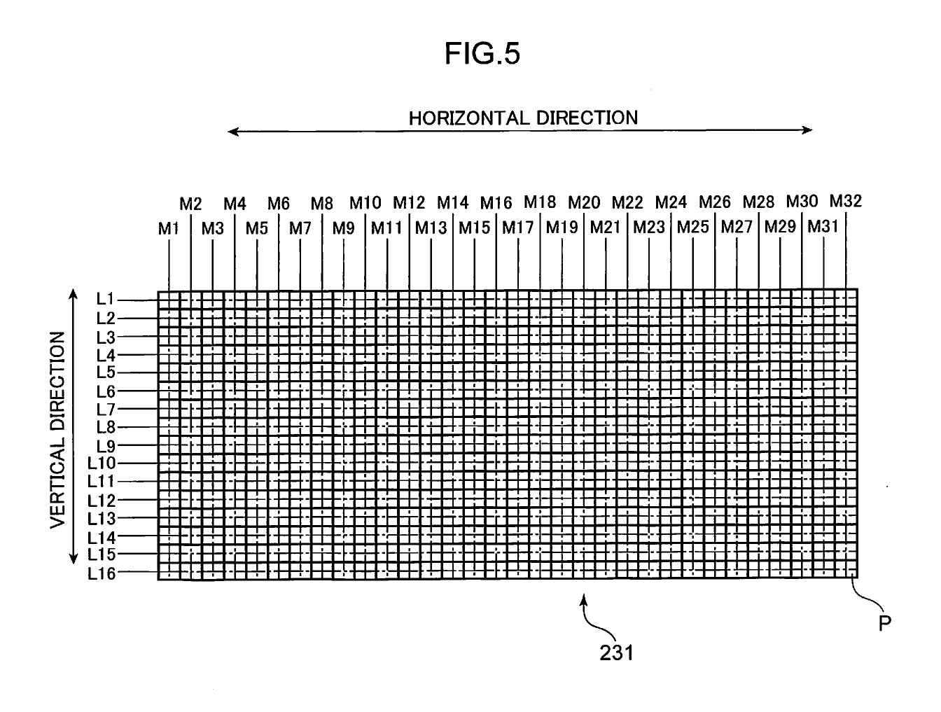

FIG. 5 is a schematic view showing a part of the liquid crystal panel 231. The video signal processor 210 and the driver 220 are described with reference to FIGS. 1, 3 and 5.

The liquid crystal panel 231 has a number of gate lines, which horizontally extend, and a number of data lines, which vertically extend. FIG. 5 shows gate lines L₁ to L₁₆ aligned in the sub-scanning direction and data lines M₁ to M₃₂ aligned in the main-scanning direction. Pixels P and liquid crystals (not shown) corresponding to the pixels P are situated at intersections between the gate lines L₁ to L₁₆ and the data lines M₁ to M₃₂. The driver 220 applies voltages to the gate lines L₁ to L₁₆ and the data lines M₁ to M₃₂ in response to the image data sent from the output portion 214 in order to drive the liquid crystal. In this embodiment, the driver 220 drives the liquid crystal in frame inversion mode. It is described later how to drive the liquid crystal in the frame inversion mode.

If the control signal to stop outputting the second image data is sent from the decision portion 215 to the output portion 214, the video signal sent from the selector 212 is processed to decrease the number of the gate lines, to which the second image data are written. For example, the output portion 214 outputs the second image data immediately after the reception of the control signal from the decision portion 215 so that the writing operation is performed only on the odd-numbered gate lines (L₁, L₃, L₅, . . . , L₂ₙ₋₁). The output portion 214 then outputs the subsequent second image data so that the writing operation is performed only on, for example, the gate lines in multiples of “3” (L₃, L₆, L₉, . . . ). The output portion 214 processes the video signal sent from the selector 212 for every output of the second image data to decrease the number of gate lines, to which the second image data are written. The output portion 214 receives the control signal from the decision portion 215 and outputs the second image data a predetermined number of times, and eventually stops outputting the second image data.

A control signal to hold the gamma value used in the gamma correction is sent from the decision portion 215 to the gamma adjuster 213 in synchronism with the output of the second image data by the output portion 214. The gamma adjuster 213 holds the gamma value used in the gamma correction in response to the control signal, and uses the held gamma value to process the video signal. The video signal directly sent to the selector 212 is output from the selector 212 to the output portion 214 in the period assigned for writing the first image data. In the period assigned for writing the second image data, the selector 212 outputs the video signal received through the gamma adjuster 213. The output portion 214, which receives the control signal to stop outputting the second image data, reduces the aforementioned gate lines, and eventually outputs only the first image data without outputting the second image data. As a result, the driver 220 drives the liquid crystal of the liquid crystal panel 231 in response to the first image data. Thus, the frame image generated in response to the first image data is displayed on the liquid crystal panel 231.

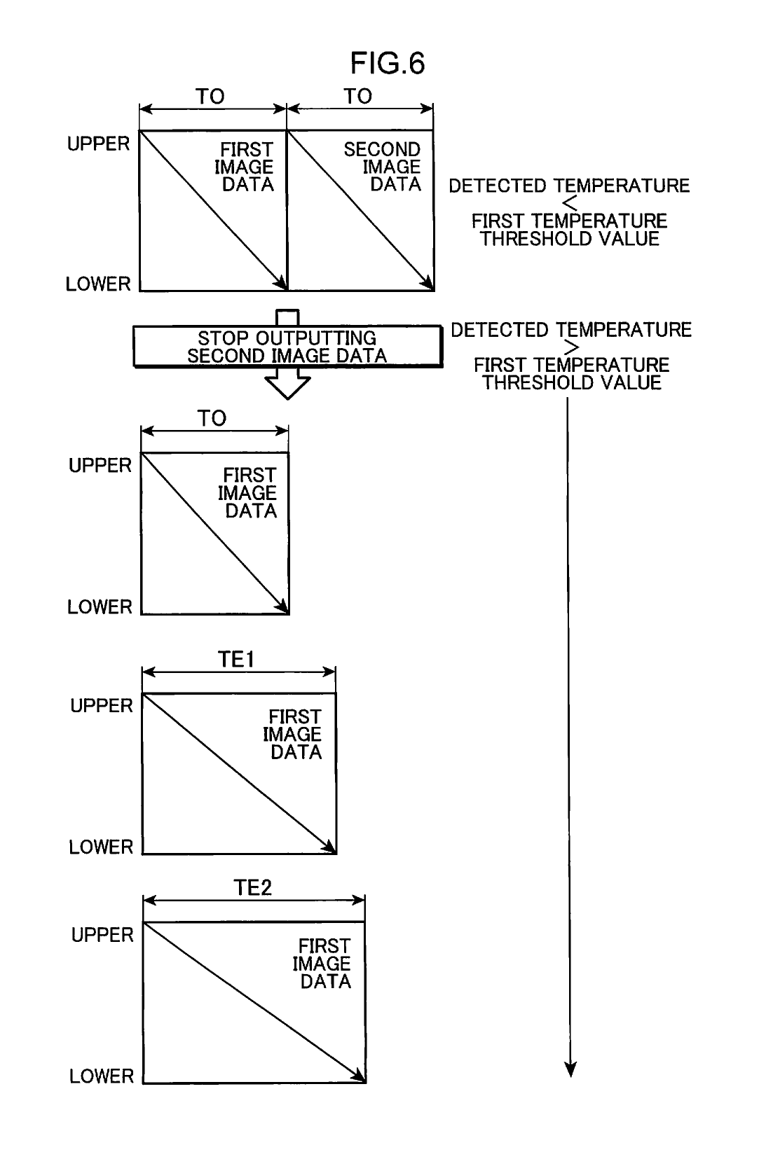

FIG. 6 is a schematic view showing how the image data are written by the driver 220. The writing operation of the driver 220 is described with reference to FIGS. 1, 3 and 6.

The output portion 214 outputs the first and second image data while the temperature of the driver 220 detected by the detector 221 is lower than the first temperature threshold value stored in the decision portion 215 as described above. The driver 220 writes the first image data to the liquid crystal panel 231, and then writes the second image data to the liquid crystal panel 231. It may take substantially as long as the second writing operation to perform the first writing operation if the temperature of the driver 220 detected by the detector 221 is lower than the first temperature threshold value stored in the decision portion 215. In FIG. 6, the period assigned for the first and second writing operations is depicted by the symbol “TO”.

As aforementioned, the output portion 214 stops outputting the second image data if the temperature of the driver 220 detected by the detector 221 exceeds the first temperature threshold value stored in the decision portion 215. It takes the time length “TO” for the driver 220 to write the first image data. The first writing operation in the time length “TO” may be performed on a predetermined number of frame images.

After the predetermined number of frame images is rendered by the first writing operation, which takes the time length “TO”, the driver 220 extends the performance period of the first writing operation. It is preferable that the performance period of the first writing operation is gradually increased in response to how many times the first writing operation is performed. As a result, a temperature drop of the driver 220 is facilitated. In FIG. 6, the extended performance periods of the first writing operation are depicted by the symbols “TE1” and “TE2”. In this embodiment, the performance period of the first writing operation “TO” shown in FIG. 6 is exemplified as the first time length. The performance periods of the second writing operation “TE1” and “TE2” are exemplified as the second time lengths.

As shown in FIG. 6, the temperature of the driver 220 is gradually decreased because the driver 220 writes the image data less frequently. The decision portion 215 stores the data about the second temperature threshold value defined for the temperature of the driver 220. The second temperature threshold value is smaller than the first temperature threshold value. The decision portion 215 outputs a control signal to the output portion 214 so that the output portion 214 restarts outputting the second image data once the detection signal indicates a lower temperature than the second temperature threshold value. A notification signal to indicate outputting the second image data is then output from the output portion 214 to the driver 220 along with the first image data. As a result, the driver 220 writes the first image data output from the output portion 214 in the time length “TO”. The driver 220 also writes the subsequent second image data in the time length “TO”. It should be noted that the output portion 214 may process the video signal sent from the selector 212 to gradually increase the number of the gate lines, to which the second image data are written, in response to how many times the second writing operation is performed. The second temperature threshold value is exemplified as the second threshold value in this embodiment.

Once the second image data, which are written to all the gate lines of the liquid crystal panel, are output from the output portion 214, the decision portion 215 outputs a control signal so that the gamma adjuster 213 restarts adjusting the gamma value. As a result, the gamma value, which is used to process the video signal, is gradually returned to the original value by the gamma adjuster 213.

### (Display Control Method for Decreasing Writing Frequency)

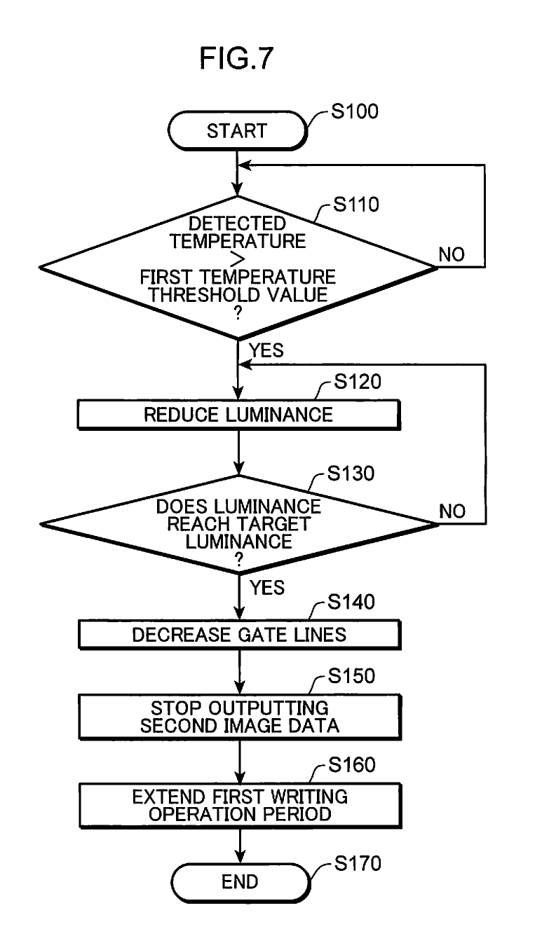

FIG. 7 is a schematic flow chart showing a display control method when the detector 221 detects a higher temperature of the driver 220 than the first temperature threshold value. The display control method is described with reference to FIGS. 1, 3 and 7.

### (Step S100)

As described above, the driver 220 writes the first and second image data to the liquid crystal panel 231. The detector 221 measures the temperature of the driver 220 to output the detection signal to the decision portion 215. The step S100 is exemplified as the step of measuring the temperature of the driver in this embodiment.

### (Step S110)

In the step S110, the decision portion 215 determines whether or not the temperature of the driver 220 exceeds the first temperature threshold value. Unless the temperature of the driver 220 is higher than the first temperature threshold value, the step S110 is repeated. The driver 220 writes the first and second image data to the liquid crystal panel 231 while the step S110 is repeated. If the temperature of the driver 220 exceeds the first temperature threshold value, the step S120 is performed. It depends on the decision at the step S110 whether the writing operation is performed twice or one time. Therefore, the step S110 is exemplified as the step of determining how many times the image data are written in this embodiment.

### (Step S120)

In the step S120, the gamma adjuster 213 adjusts the gamma value to reduce the luminance level of the second image data. Then, the step S130 is performed.

### (Step S130)

In the step S130, the decision portion 215 determines whether or not the luminance level reaches the target luminance level. Unless the luminance level reaches the target luminance level, the step S120 is performed again to further reduce the luminance level. If the luminance level reaches the target luminance level, the step S140 is performed.

### (Step S140)

In the step S140, the output portion 214 processes the video signal from the selector 212 to decrease the number of the gate lines, to which the second image data are written. As a result, the driver 220 writes the second image data to the decreased number of the gate lines. The step S140 is performed over a display period for several frame images. Meanwhile the number of the gate lines, to which the second image data are written, is gradually decreased. In the step S140, the liquid crystal panel 231 displays a predetermined number of frame images, and the step S150 is then performed.

### (Step S150)

In the step S150, the output portion 214 stops outputting the second image data. It should be noted that the output portion 214 continues outputting the first image data. After the liquid crystal panel 231 displays a predetermined number of frame images in the step S150, the step S160 is performed.

### (Step S160)

In the step S160, the driver 220 extends the period of the first writing operation. The step S160 is performed over a display period for several frame images, during which the performance period of the first writing operation is gradually extended. After the liquid crystal panel 231 displays a predetermined number of frame images in the step S160, the step S170 is performed.

### (Step S170)

In the step S170, the driver 220 writes the first image data in the period extended in the step S160. The step S170 and the aforementioned step S100 are processes to write the image data by the number of times determined in response to the decision in the step S110 to display the frame image on the liquid crystal panel 231. Thus, the steps S170 and S100 are exemplified as the step of displaying the frame image on the liquid crystal panel.

### (Luminance Adjustment)

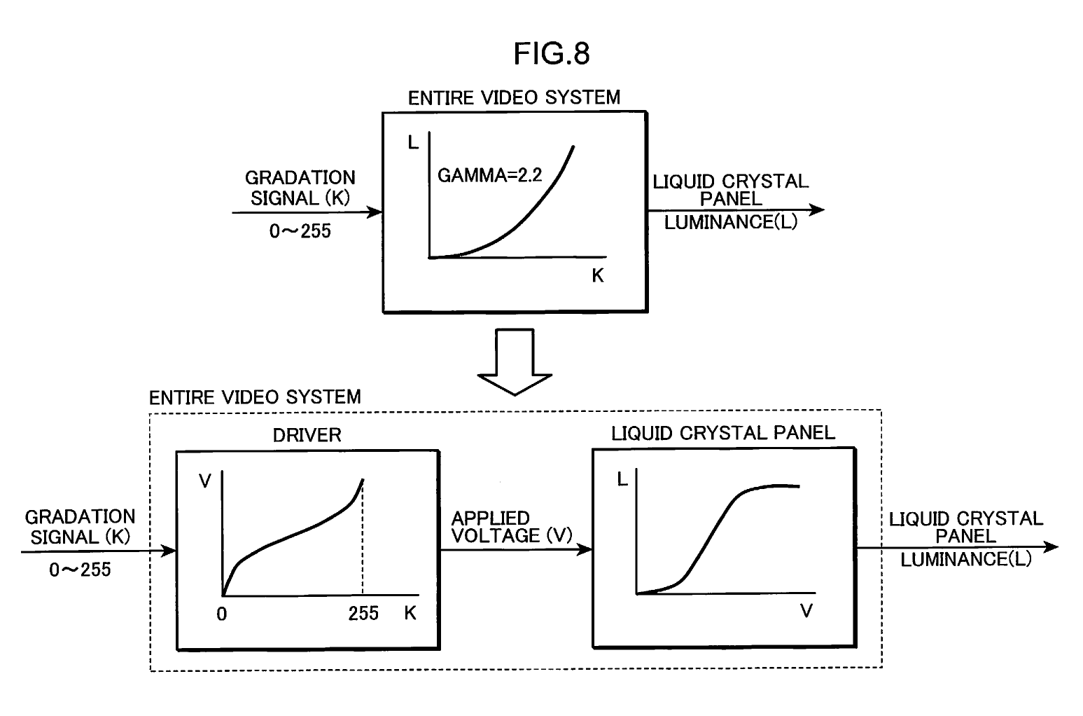

FIG. 8 is a conceptual view of luminance adjustment on the first image data. The luminance adjustment on the first image data is described with reference to FIGS. 1, 3 and 8.

The first image data are generated in response to the video signal directly output to the selector 212 as described above with reference to FIG. 3. For example, the video system 100 converts a gradation signal contained in the video signal in the signal processing route without the gamma adjuster 213 into the luminance of the liquid crystal panel 231 by means of a gamma correction of “gamma value=2.2”.

In the display of the frame image in response to the first image data, the driver 220 and the liquid crystal panel 231 are major elements to determine the luminance of pixels of the liquid crystal panel 231 in response to the gradation signal which defines the luminance of a pixel corresponding to every liquid crystal.

The output portion 214 outputs the first image data including the gradation signal. The driver 220 converts “K value” defined by the gradation signal into a voltage value, “V value”. The driver 220 applies the voltage corresponding to the “V value” to the liquid crystal panel 231. The pixels of the liquid crystal panel 231 emit light at the luminance in response to the applied voltage.

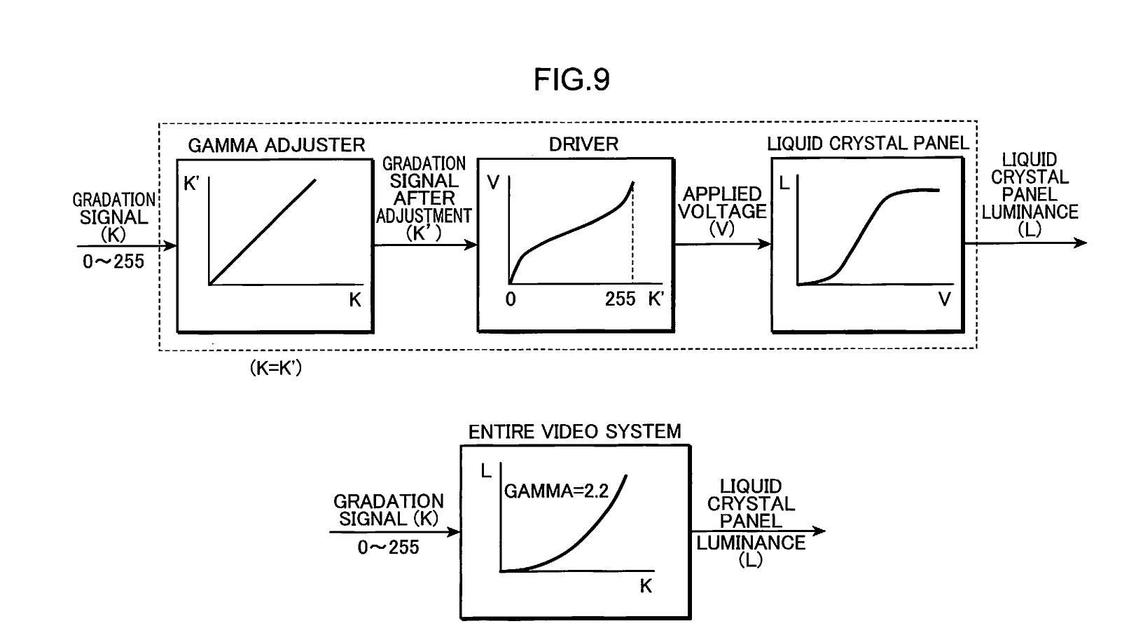

FIG. 9 is a conceptual view of luminance adjustment on the second image data in the step S100, which is described with reference to FIG. 7. The luminance adjustment of the second image data is described with reference to FIGS. 1, 3, 7 to 9.

As described above with reference to FIG. 3, the second image data are generated in response to the video signal output to the selector 212 through the gamma adjuster 213. Thus, in the display of the frame image in response to the second image data in the step S100, the major elements to determine the luminance of pixels of the liquid crystal panel 231 in response to the gradation signal, which defines the luminance of a pixel corresponding to every liquid crystal, are the gamma adjuster 213 in addition to the driver 220 and the liquid crystal panel 231.

In the step S100, the gamma adjuster 213 outputs “K′ value”, which is equal to the “K value” defined by the gradation signal. Accordingly, the gamma correction of “gamma value=2.2” is performed on the entire video system 100, like the gamma correction on the first image data, which is described above with reference to FIG. 8.

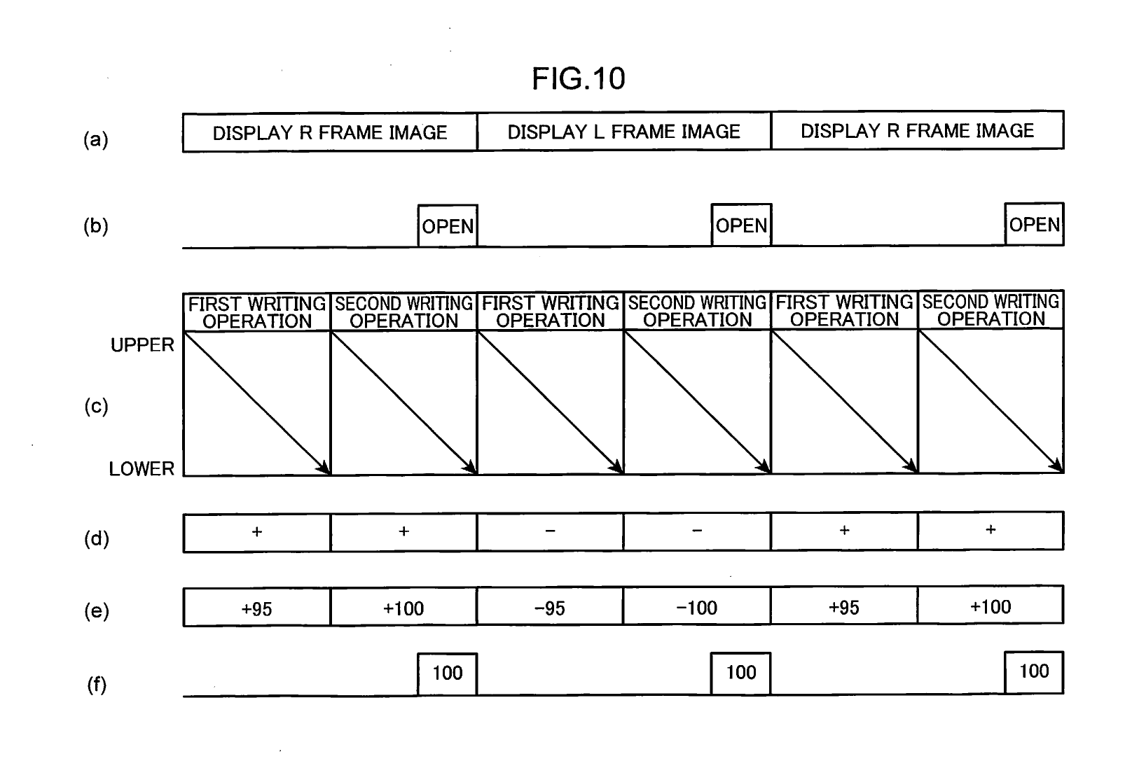

FIG. 10 is a schematic timing chart showing an operation of the video system 100 in the aforementioned step S100 with reference to FIG. 7. The operation of the video system 100 in the step S100 is described with reference to FIGS. 1, 3, 7 to 10.

The section (a) in FIG. 10 shows displayed frame images. As shown by the section (a) in FIG. 10, the liquid crystal panel 231 alternately displays the R and L frame images.

In order to clearly describe the principle of the luminance adjustment, in the descriptions with reference to FIG. 10, the video system 100 displays white video images for both of the R and L frame images.

The section (c) in FIG. 10 schematically shows an operation to write image data to the liquid crystal panel 231 by the driver 220. As described above, in order to display the R or L frame image, the driver 220 performs the first writing operation (writing the first image data) and the second writing operation (writing the second image data). The writing operation begins at an upper area of the liquid crystal panel 231 and ends at a lower area thereof.

The section (b) in FIG. 10 shows an operation of the optical shutter portion 310. The optical shutter portion 310 opens the right or left shutter 312, 311 once the second writing operation is ended. While the right shutter 312 is kept open, the viewer views the R frame image. While the left shutter 311 is kept open, the viewer views the L frame image.

The section (d) in FIG. 10 shows polarities of a voltage applied during the first and second writing operations. A voltage of the positive polarity is applied during the display of the R frame image. A voltage of the negative polarity is applied during the display of the L frame image. As a result, it becomes easier to keep a medium potential. One of the positive and negative polarities is exemplified as the first polarity, and the other is exemplified as the second polarity in this embodiment.

The section (e) in FIG. 10 shows a potential charged in a pixel. The section (e) in FIG. 10 contains numeric values such as “+95”, “+100”, “−95” and “−100”. The symbols “+” and “−” mean the polarity of the voltage described with reference to the section (d) in FIG. 10. The numeric values such as “+95”, “+100”, “−95” and “−100” mean a charging potential of the pixel. The numeric value “±100” means a potential for displaying “white” in the descriptions with reference to the section (e) in FIG. 10. The numeric value “±95” means a darker hue than “white” (e.g., gray).

As shown in the section (e) in FIG. 10, the period of the first writing operation is short, so that in the initial display of the R frame image, the charging potential does not reach the target value of “+100”. In the subsequent second writing operation, the charging potential reaches the value of “+100”.

In order to subsequently display the L frame image, the driver 220 changes the polarity of the applied voltage from “positive” to “negative”. In order to display a white L frame image, like the R frame image, it is required that the charging potential is varied from “+100” to “−100”, but the period of the first writing operation performed for displaying the L frame image is too short to vary the charging potential in this range. As a result, at the end of the first writing operation performed for displaying the L frame image, the charging potential has a value of “−95”. In the subsequent second writing operation, the charging potential reaches a value of “−100”.

The section (f) in FIG. 10 shows luminance perceived by the viewer through the eyeglass device 300. The numeric value “100” shown in the section (f) in FIG. 10 means that a “white” frame image is viewed. It should be noted that numeric values no more than “100” mean darker hues than “white” (e.g., gray).

If the step S150 (stop outputting the second image data), which is described with reference to FIG. 7, is performed immediately after it is detected that the temperature of the driver 220 exceeds the first temperature threshold value in the step S110, the viewer suddenly views a frame image displayed at a hue corresponding to the charging potential of “±95” achieved in the first writing operation (i.e., the viewer suddenly views a frame image at a darker hue than “white”). Such a sudden change in luminance makes the viewer feel video images strange. Therefore, the operations in the steps S120 and S130, which are described with reference to FIG. 7, make the luminance perceived by the viewer closer to the luminance achieved in the first writing operation.

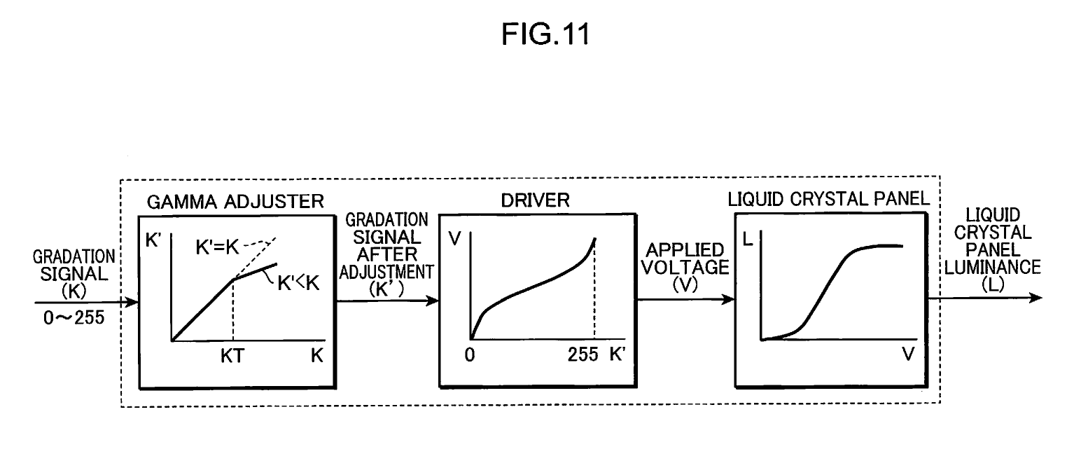

FIG. 11 is a conceptual view of the luminance adjustment on the second image data in the step S120, which is described with reference to FIG. 7. The luminance adjustment on the second image data is described with reference to FIGS. 1, 3, 7, 9 and 11.

Once the step S120 begins, the gamma adjuster 213 outputs a “K′ value”, which is smaller than the “K value” (luminance value) defined by the received gradation signal, for a gradation region where the “K value” of the gradation signal exceeds “KT”. In the processes on the gradation signal shown in FIG. 9, the gamma adjuster 213 outputs the “K′ value”, which is equal to the “K value” of the received gradation signal. Therefore, the gamma adjuster 213 does not substantially contribute to the gamma correction of the entire video system 100 (operation to determine the luminance of the liquid crystal panel 231 in response to the received gradation signal). Once the step S120 begins, however, the gamma adjuster 213 processes the input signal so that a relationship of “K′ value<K value” is obtained in the gradation region exceeding the “KT”. Therefore, any regions in the frame image represented by the luminance exceeding the “KT” become darker. Thus, the gamma adjuster 213 changes its own output characteristics to adjust the gamma values used for the gamma correction of the video system 100 in the regions exceeding the “KT”. The output characteristics of the gamma adjuster 213 in the gradation region, which does not exceed the “KT”, are consistent between the steps S100 and S120. Therefore, an equivalent gradation value to an input value of the gradation signal, which is output to the gamma adjuster 213, is output (K value=K′ value) for any regions in the frame image represented by the luminance corresponding to the regions which do not exceed the “KT”.

In general, change in luminance is more likely to be perceived in high luminance regions and less likely to be perceived in low luminance regions. Thus, if the output characteristics of the gamma adjuster 213 are changed in a high luminance region, luminance in image regions where the viewer is likely to perceive the luminance change is set to be lower than the luminance defined by the video signal output to the video signal processor 210. On the other hand, the luminance in image regions where the viewer is less likely to perceive the luminance change is set to be equal to the luminance defined by the video signal output to the video signal processor 210.

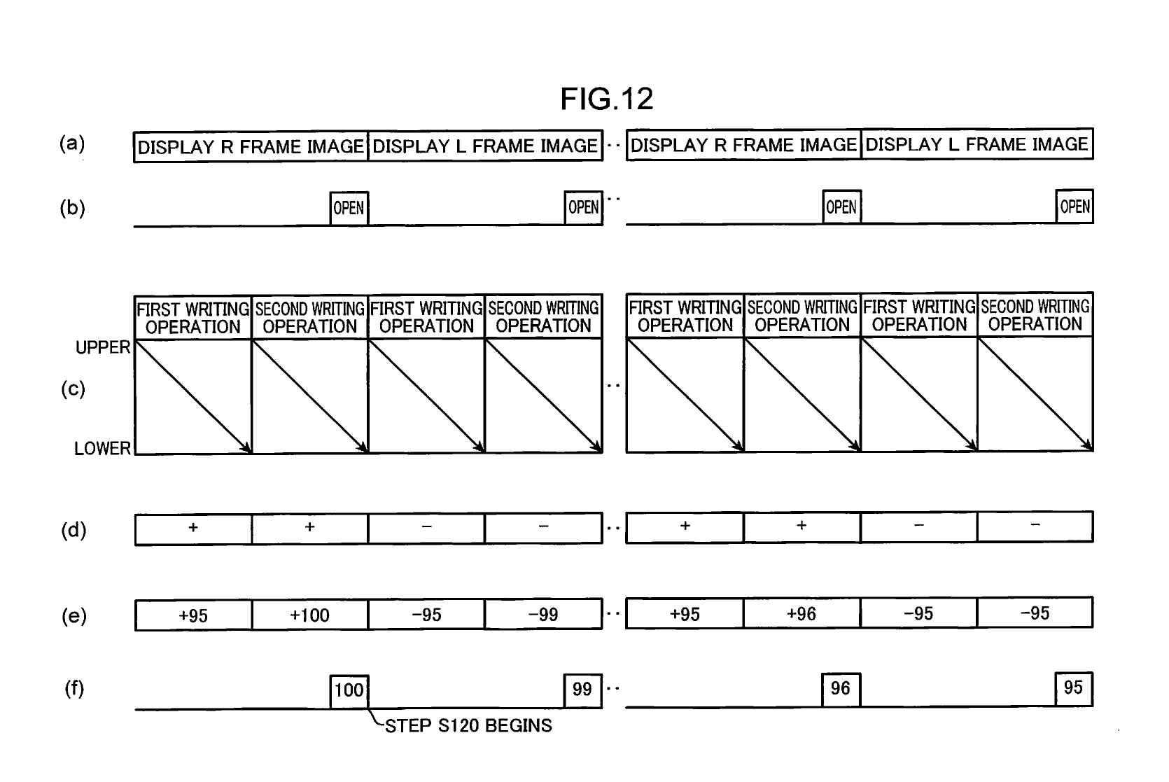

FIG. 12 is a schematic timing chart showing an operation of the video system 100 in the step S120, which is described with reference to FIG. 7. The operation of the video system 100 in the step S120 is described with reference to FIGS. 1, 3, 7, 10 to 12.

The sections (a) to (d) in FIG. 12 correspond to the sections (a) to (d) in FIG. 10, respectively.

It may be figured out that the charging potential achieved in the second writing operation is gradually reduced, with comparing the section (e) in FIG. 12 to the section (e) in FIG. 10. The gamma adjuster 213 changes its output characteristics if the step S120 starts decreasing the charging potential as described with reference to FIG. 11. Thus, the subsequent L and R frame images have a lower luminance level than the preceding L and R frame images. As a result, the luminance of the frame image which the viewer perceives gradually becomes lower.

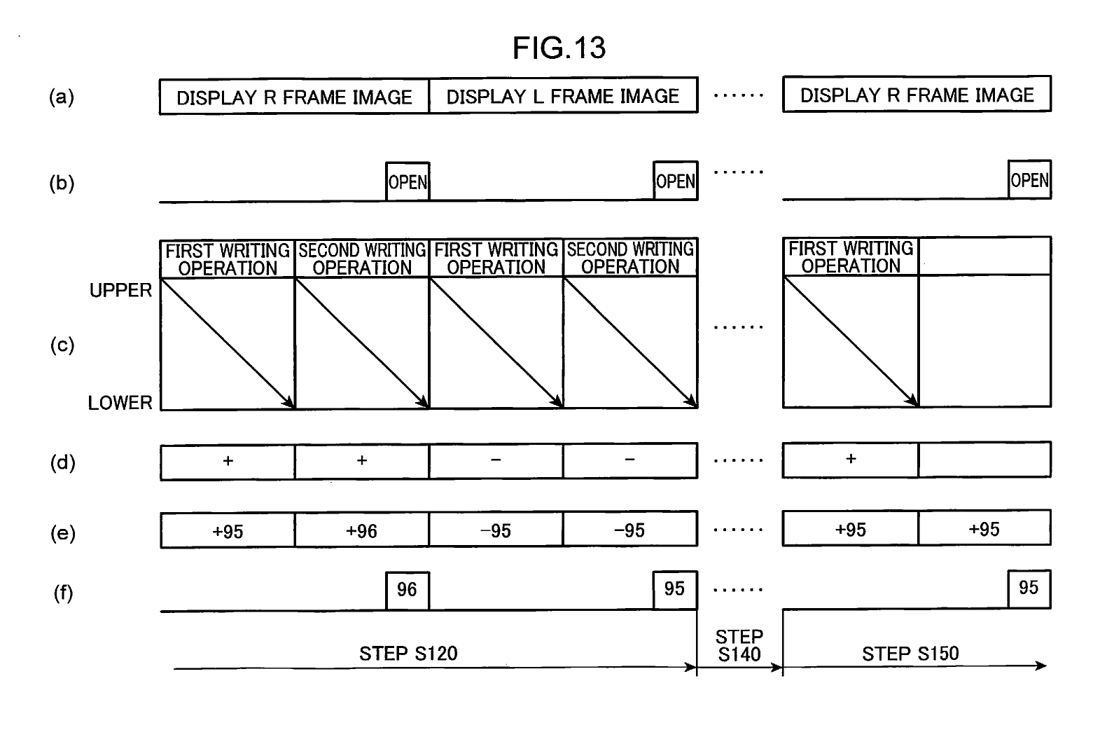

FIG. 13 is a schematic timing chart showing an operation of the video system 100 in the processes from the steps S120 to S150, which are described with reference to FIG. 7. The operation of the video system 100 in the processes from the steps S120 to S150 is described with reference to FIGS. 1, 3, 7, 11 to 13.

The sections (a) to (d) in FIG. 13 correspond to the sections (a) to (d) in FIG. 12, respectively.

As described with reference to FIG. 7, in the step S120, after the luminance is reduced, the steps S140 and S150 are performed. Once the step S140 begins, the gamma adjuster 213 keeps its output characteristics. The gamma adjuster 213 outputs the gradation signal by means of output characteristics, which are similar to the output characteristics used to generate the second image data written in the second writing operation at the end of the step S120 if the step S140 begins. Thus, the second writing operation achieves “±95” of the charging potential during the execution of the step S140. Accordingly, it becomes less likely that the viewer perceives the change in luminance between the steps S120 and S140.

As described above, in the step S140, the number of the gate lines, to which the second image data are written in the second writing operation, is gradually decreased. Thus, in the step S150, even if the second writing operation is terminated, it becomes less likely that the viewer perceives the operational change of the driver 220 (termination of the second writing operation).

### (Display Control Method for Increasing Writing Frequency)

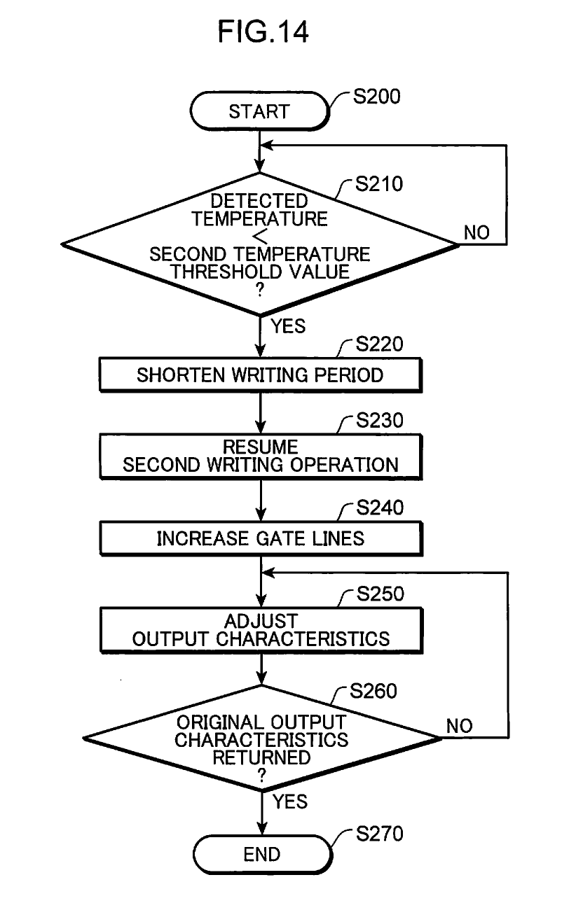

FIG. 14 is a flow chart schematically showing a display control method when the detector 221 detects a lower temperature of the driver 220 than the second temperature threshold value. The display control method is described with reference to FIGS. 1, 3, 5, 7, 9 and 14.

### (Step S200)

The step S200 corresponds to the step S170, which is described with reference to FIG. 7. The driver 220 writes only the first image data to the liquid crystal panel 231. The detector 221 measures the temperature of the driver 220 to output the detection signal to the decision portion 215.

### (Step S210)

The decision portion 215 determines whether or not the temperature of the driver 220 is lower than the second temperature threshold value in the step S210. Unless the temperature of the driver 220 is lower than the second temperature threshold value, the step S210 is repeated. The driver 220 writes only the first image data to the liquid crystal panel 231 while the step S210 is repeated. If the temperature of the driver 220 is lower than the second temperature threshold value, the step S220 is performed.

### (Step S220)

In the step S220, the driver 220 writes the first image data in a writing period (writing period “TO” (c.f., FIG. 5)) before the execution of the step S160, which is described with reference to FIG. 7. As a result, there remains a time period long enough to write the subsequent second image data. Once the driver 220 writes the first image data in the original writing time length, the step S230 is performed.

### (Step S230)

There remains a time period long enough to write the subsequent second image data in the aforementioned step S220. The second image data are written in the ensured time period in the step S230. It should be noted that, in the step S230, the second image data are written to a relatively small number of the gate lines. After the second image data are written, the step S240 is performed.

### (Step S240)

In the step S240, the output portion 214 adjusts the second image data so that the driver 220 gradually increases the number of the gate lines to which the second image data are written. Once the second image data are output so that the driver 220 writes the second image data to all the gate lines, the step S250 is performed.

### (Step S250)

In the step S250, the gamma adjuster 213 adjusts its output characteristics so that the output characteristics become closer to the output characteristics which are described with reference to FIG. 9. As a result, the frame image rendered on the liquid crystal panel 231 has a high luminance. The step S260 is performed after the gamma adjuster 213 adjusts its output characteristics.

### (Step S260)

The decision portion 215 determines in the step S260 whether or not the output characteristics of the gamma adjuster 213 are returned to the output characteristics which are described with reference to FIG. 9. The step S250 is again performed unless the output characteristics of the gamma adjuster 213 are returned to the output characteristics which are described with reference to FIG. 9. Thus, the luminance of the frame image rendered on the liquid crystal panel gradually becomes higher. The step S270 is performed if the output characteristics of the gamma adjuster 213 are returned to the output characteristics, which are described with reference to FIG. 9.

### (Step S270)

The step S270 corresponds to the step S100 described with reference to FIG. 7. The driver 220 writes the first and second image data to the liquid crystal panel 231.

### Second Embodiment

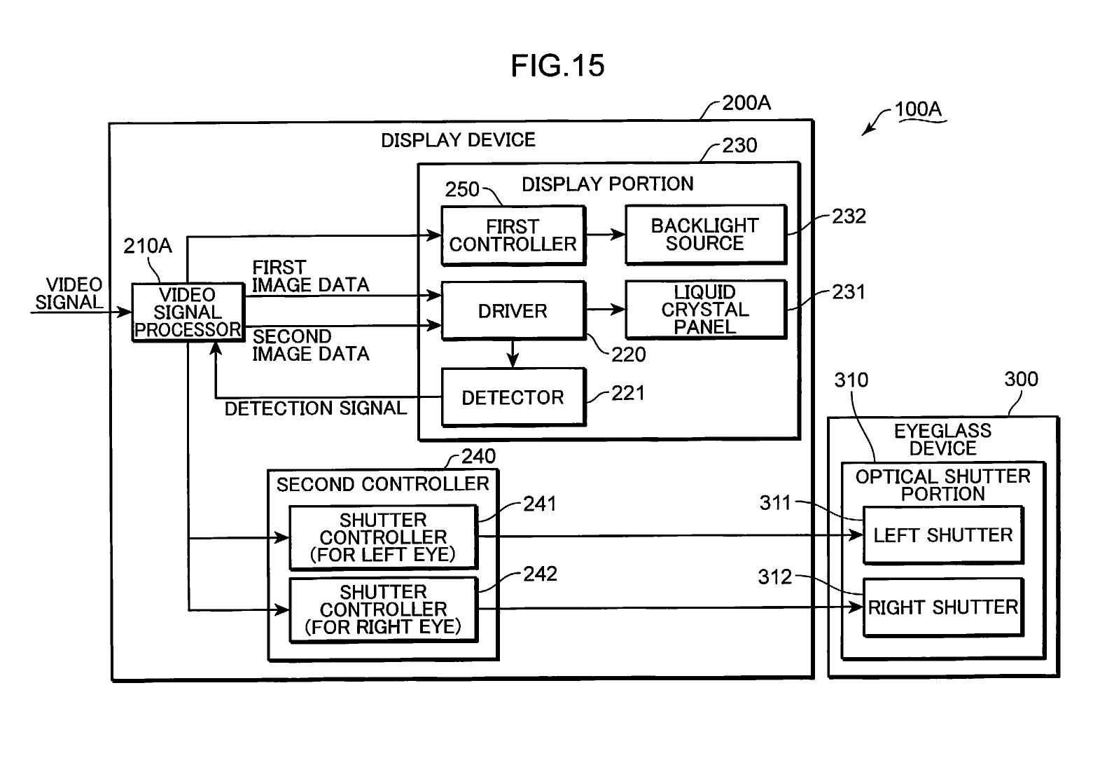

FIG. 15 is a schematic block diagram showing a configuration of a video system including a display device according to the second embodiment. The schematic configuration of the video system is described with reference to FIG. 15. It should be noted that any elements similar to those described in the context of the first embodiment are depicted with similar reference numerals. The following descriptions mainly direct to a difference from the first embodiment. For similar features to the first embodiment, the descriptions in the first embodiment are incorporated by reference.

A video system 100A comprises a display device 200A in addition to the eyeglass device 300 which is described in the context of the first embodiment. The display device 200A comprises a video signal processor 210A in addition to the display portion 230 and the second controller 240, which are described in the context of the first embodiment.

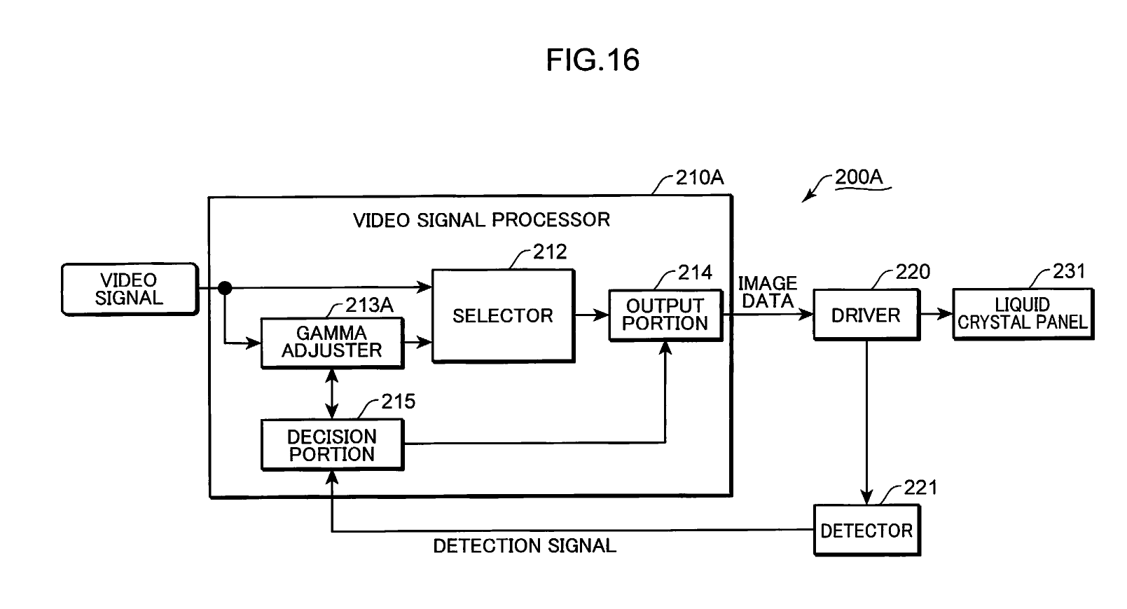

FIG. 16 is a schematic block diagram showing a functional configuration of the video signal processor 210A of the display device 200A. The video signal processor 210A is described with reference to FIGS. 7, 14 to 16.

The video signal processor 210A comprises a gamma adjuster 213A in addition to the selector 212, the output portion 214 and the decision portion 215, which are described in the context of the first embodiment. The second embodiment is different from the first embodiment in output characteristics of the gamma adjuster 213A. It should be noted that the display device 200A performs the control to increase and decrease the number of the writing operations which are described in the context of FIGS. 7 and 14, by means of the gamma adjuster 213A.

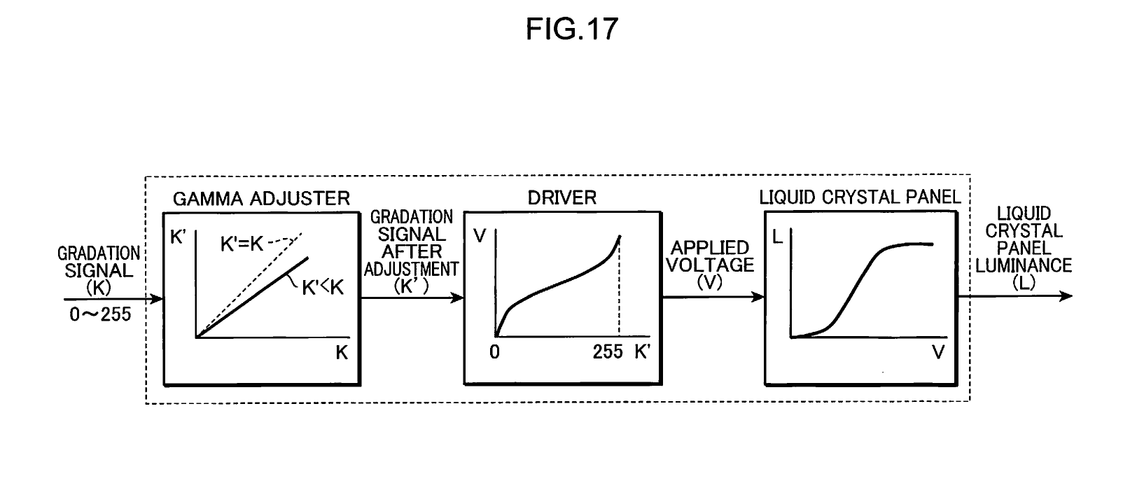

FIG. 17 schematically shows the output characteristics of the gamma adjuster 213A. Differences between the gamma adjusters 213, 213A according to the first and second embodiments are described with reference to FIGS. 3, 7, 11, 15 and 17.

If the step S120 described with reference to FIG. 7 begins, the gamma adjuster 213A changes its output characteristics. Unlike the gamma adjuster 213 of the first embodiment, the gamma adjuster 213A outputs a smaller “K′ value” than the “K value” of the received gradation signal over the entire graduation region defined by the gradation signal. As a result, the gamma value for the entire video system 100A is decreased over the entire gradation region defined by the gradation signal. Thus, execution of the step S120 leads to luminance change not only in high luminance image regions of the frame image rendered in response to the second image data but also in low luminance image regions according to the second embodiment. However, arithmetic operations in the step S120 are simplified because the output adjustment by the gamma adjuster 213A does not involve any processes associated with the threshold value “KT” (c.f., FIG. 11) defined for luminance regions.

### Third Embodiment

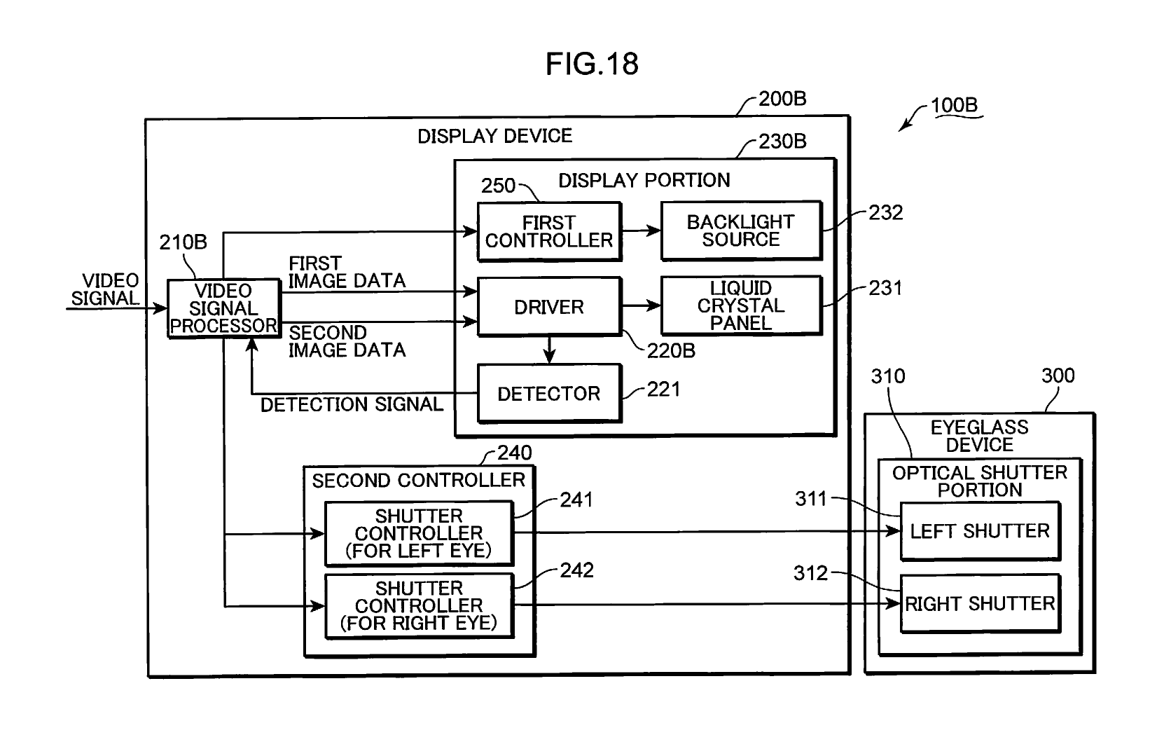

FIG. 18 is a schematic block diagram showing a configuration of a video system including a display device according to the third embodiment. The schematic configuration of the video system is described with reference to FIG. 18. It should be noted that any elements similar to those described in the context of the first embodiment are depicted by similar reference numerals. The following descriptions mainly direct to differences from the first embodiment. For similar features to the first embodiment, the descriptions in the first embodiment are incorporated by reference.

The video system 100B comprises a display device 200B in addition to the eyeglass device 300 which is described in the context of the first embodiment. The display device 200B has a display portion 230B and a video signal processor 210B in addition to the second controller 240 which is described in the context of the first embodiment.

The display portion 230B has a driver 220B, in addition to the first controller 250, the backlight source 232, the liquid crystal panel 231 and the detector 221, which are described in the context of the first embodiment. The driver 220B is different from the driver 220, which is described in the context of the first embodiment, in a driving pattern of frame inversion, which is described later.

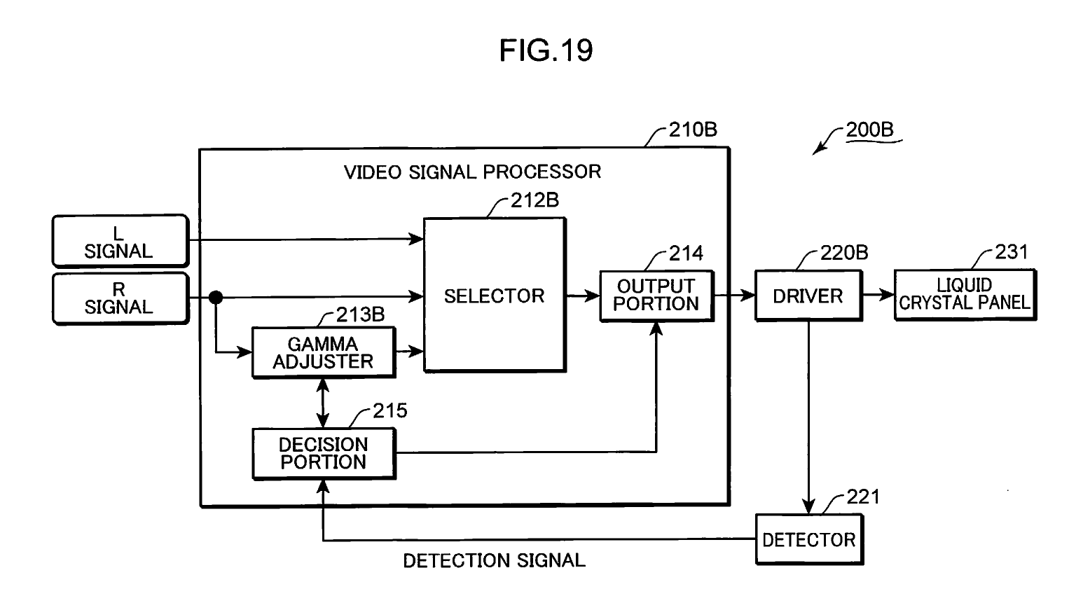

FIG. 19 is a schematic block diagram showing a functional configuration of the video signal processor 210B of the display device 200B. The video signal processor 210B is described with reference to FIGS. 18 and 19.

The video signal processor 210B has a selector 212B and a gamma adjuster 213B, in addition to the output portion 214 and the decision portion 215, which are described in the context of the first embodiment. Unlike the first embodiment, the L signal for displaying the L frame image is output to the selector 212B without passing through the gamma adjuster 213B. On the other hand, a path directly entering the selector 212B and a path entering the selector 212B through the gamma adjuster 213B are provided for the R signal for displaying the R frame image, like the first embodiment. It should be noted that the principle of signal processes by the gamma adjuster 213B is similar to the signal processes performed by the gamma adjuster 213, which is described in the context of the first embodiment. Instead, the gamma adjuster 213B may perform signal processes, which are performed by the gamma adjuster 213A described in the context of the second embodiment.

The L signals used in the first and second writing operations are output from the selector 212B to the output portion during the display period of the L frame image. The R signals used in the first and second writing operations are output from the selector 212B to the output portion 214 in the display period of the R frame image. The R signal used in the first writing operation is directly output to the selector 212B. The R signal used in the second writing operation is output to the selector 212B through the gamma adjuster 213B. The gamma adjuster 213B works only for the R signal in this embodiment. Instead, the gamma adjuster may work only for the L signal.

The first image data generated in response to the L and R signals, which are used in the first writing operation, are output from the output portion to the driver 220B. The second image data generated in response to the L and R signals, which are used in the second writing operation, are output from the output portion 214 to the driver 220B. It should be noted that the display device 200B performs the control to increase and decrease the number of the writing operations, which are described with reference to FIGS. 7 and 14, by means of the gamma adjuster 213B.

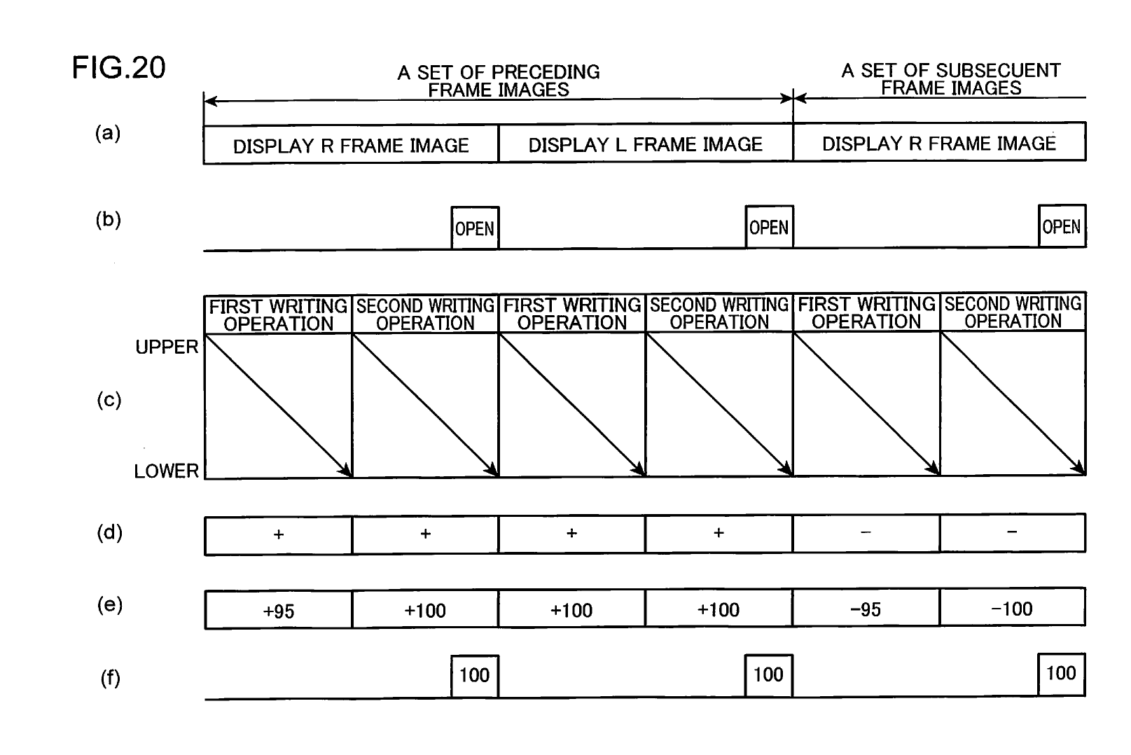

FIG. 20 is a schematic timing chart showing an operation of the video system 100B in the step S100 which is described with reference to FIG. 7. Differences between the operation of the video system 100, which is described with reference to FIG. 10, and the operation of the video system 100B in this embodiment are described with reference to FIGS. 7, 10, 18 to 20.

The sections (a) to (c) and the section (f) in FIG. 20 correspond to the sections (a) to (c) and the section (f) in FIG. 10, respectively.

The section (d) in FIG. 20 shows polarities of a voltage applied during the first and second writing operations. The driver 220 in the first embodiment switches the polarity of the voltage once every frame image but the driver 220B in the third embodiment switches the polarity of the voltage once every set of the R and L frame images. In order to clarify the principle of the luminance adjustment, in the descriptions with reference to FIG. 20, the display device 200B displays white video images for both of the R and L frame images. However, if the display device 200B displays a stereoscopic video image, the R and L frame images included in one set may show different content from each other by a parallax amount. The section (a) in FIG. 20 shows the set of the preceding frame images and a part of the set of the subsequent frame images. In this embodiment, the set of the preceding frame images is exemplified as the first set of frame images. In addition, the set of the subsequent frame images is exemplified as the second set of frame images.

The driver 220B applies a voltage of the positive polarity to display the set of the preceding frame images and perform the first and second writing operations as shown in the section (d) in FIG. 20. The driver 220B then applies a voltage of the negative polarity to display the set of the subsequent frame images and perform the first and second writing operations. Thereafter, the driver 220B applies a voltage of the positive polarity. The driver 220B alternates the polarities of the applied voltage in this way.

The R frame image is displayed before the L frame image in this embodiment as shown in the section (a) in FIG. 20. Instead, the L frame image may be displayed before the R frame image.

The section (e) in FIG. 20 shows a potential charged in a pixel. The section (e) in FIG. 20 contains numeric values such as “+95”, “+100”, “−95” and “−100”. The symbols “+” and “−” mean the polarity of the voltage. The numeric values such as “+95”, “+100”, “−95” and “−100” mean the charging potential of the pixel. In the descriptions with reference to the section (e) in FIG. 20, the numeric value “±100” means a potential for representing “white”. The numeric value “±95” means a darker hue than “white” (e.g., gray).

The driver 220B switches the polarity of the applied voltage from “negative” to “positive” to write the first image data corresponding to the R frame image to the liquid crystal panel 231 at the beginning of the first writing operation on the R frame image of the set of the preceding frame images. The resultant charging potential from the first writing operation does not reach the target charging potential of “100”. The driver 220B then writes the second image data corresponding to the R frame image to the liquid crystal panel 231 (second writing operation). The second writing operation compensates for the insufficient charging in the first writing operation, so that the charging potential reaches the target “100” at the end of the display period of the R frame image.

After the display period for the R frame image, the display period for the L frame image begins. The driver 220B does not switch the polarity of the applied voltage between the display periods for the R and L frame images. Thus, unlike the first embodiment, the driver 220B applies the “positive” voltage at the same time of displaying the R frame image to write the first image data corresponding to the subsequent L frame image to the liquid crystal panel 231. Unlike the R frame image, there is no insufficient charging, which results from the polarity switching operation of the applied voltage, so that the charging potential reaches the target value of “100” at the end of the first writing operation for the L frame image. The second writing operation for the L frame image is then performed. Since the charging potential reaches the target value of “100” in the first writing operation, the charging potential of “100” is kept after the second writing operation.

The driver 220B switches the polarity of the applied voltage from “positive” to “negative” at the beginning of the first writing operation on the R frame image of the set of the subsequent frame images to write the first image data corresponding to the R frame image to the liquid crystal panel 231. The resultant charging potential from the first writing operation does not reach the target charging potential of “−100”. The driver 220B then writes the second image data corresponding to the R frame image on the liquid crystal panel 231 (second writing operation). The second writing operation compensates for the insufficient charging in the first writing operation, so that the charging potential reaches the target “−100” at the end of the display period of the R frame image.

After the display period for the R frame image, the display period for the L frame image begins. The driver 220B does not switch the polarity of the applied voltage between the display periods for the R and L frame images. Thus, unlike the first embodiment, the driver 220B applies the “negative” voltage at the same time of displaying the R frame image to write the first image data corresponding to the subsequent L frame image to the liquid crystal panel 231. Unlike the R frame image, there are no insufficient charging, which results from the switching operation of the polarities of the applied voltage, so that at the end of the first writing operation for the L frame image, the charging potential reaches the target value of “−100”. Then, the second writing operation for the L frame image is performed. Since the charging potential reaches the target value of “−100” in the first writing operation, the charging potential of “−100” is kept after the second writing operation.

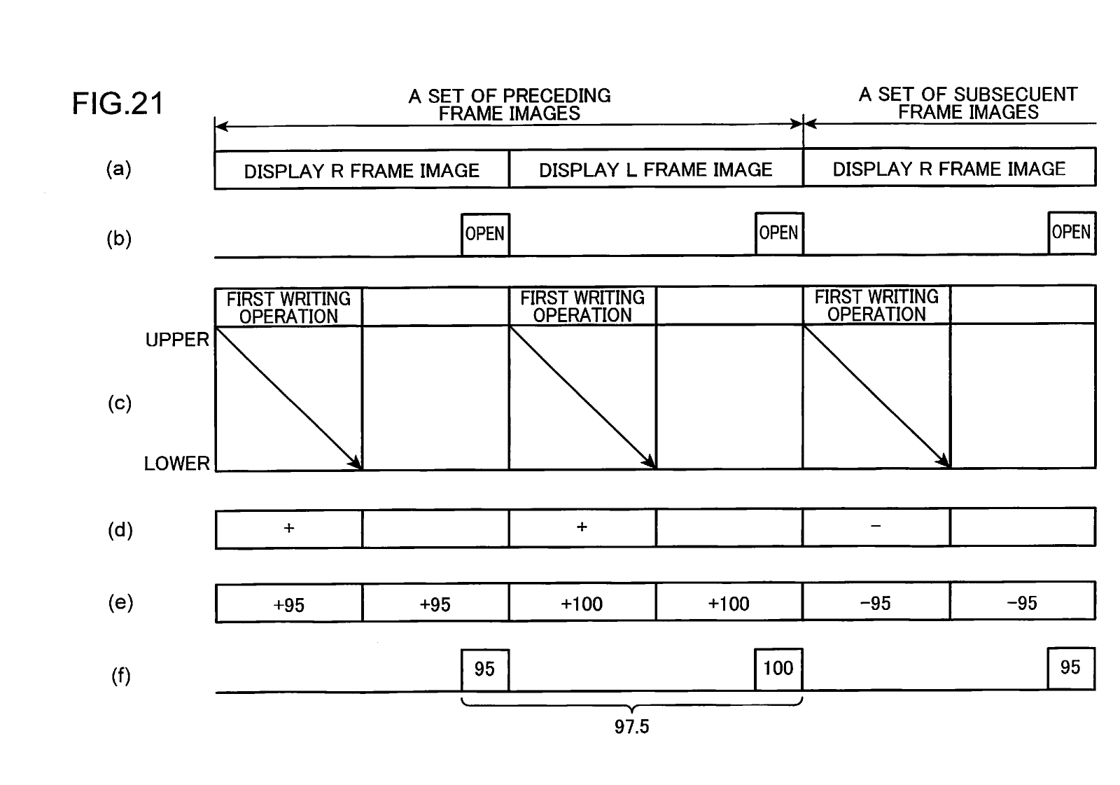

FIG. 21 is a schematic timing chart showing an operation of the video system 100B in the aforementioned step S150 with reference to FIG. 7. The operation of the video system 100B is described with reference to FIGS. 7, 18 to 21.

The sections (a) to (c) in FIG. 21 correspond to the sections (a) to (c) in FIG. 20, respectively.

As described with reference to FIG. 7, the video signal processor 210B stops outputting the second image data during the step S150. Therefore, the driver 220B performs only the first writing operation without the second writing operation.

The section (d) in FIG. 21 shows the polarities of the voltage applied by the driver 220B. The driver 220B performing the first writing operation applies a voltage of the positive polarity to display the set of the preceding frame images, and then applies a voltage of the negative polarity to display the set of the subsequent frame images.

The section (e) in FIG. 21 shows a potential charged in a pixel. The driver 220B switches the polarity of the applied voltage from “negative” to “positive” at the beginning of the first writing operation on the R frame image of the set of the preceding frame images to write the first image data corresponding to the R frame image to the liquid crystal panel 231. The resultant charging potential from the first writing operation does not reach the target charging potential of “100”. The driver 220B then writes the first image data corresponding to the L frame image to the liquid crystal panel 231 (first writing operation). The first writing operation for the L frame image compensates for the insufficient charging in the first writing operation for the R frame image, so that the charging potential reaches the target “100”.

In the display period for the set of the subsequent frame images, the R frame image is displayed under insufficient charging potential whereas the L frame image is displayed under the target charging potential.

The section (f) in FIG. 21 shows luminance perceived by the viewer through the eyeglass device 300. The numeric value “100” shown in the section (f) in FIG. 21 means that a “white” frame image is viewed. It should be noted that numeric values which is no more than “100” mean darker hues than “white” (e.g., gray).

As shown in the section (b) in FIG. 21, the right and left shutters 312, 311 of the optical shutter portion 310 are opened at the end of the display period for each of the R and L frame images.

The charging potential achieved in the first writing operation corresponding to the R frame image of the set of the preceding frame images is kept while the right shutter 312 is opened. Thus, the viewer views a frame image represented at a hue corresponding to the charging potential of “+95” (i.e., the viewer views a frame image at a darker hue than “white”).

The charging potential achieved in the first writing operation corresponding to the L frame image of the set of the preceding frame images is kept while the left shutter 311 is opened. Thus, the viewer views a frame image represented at a hue corresponding to the charging potential of “+100” (i.e., the viewer views a “white” frame image).

The viewer perceives an average luminance of the R and L frame images for the set of the preceding frame images (likewise, the set of the subsequent frame images). Thus, the luminance perceived by the viewer is “97.5” (a frame image at a darker hue than “white”).

As described with reference to FIG. 7, the step S120 is performed in order to make the resultant luminance change less perceptible for the viewer from the halt of the second writing operation.

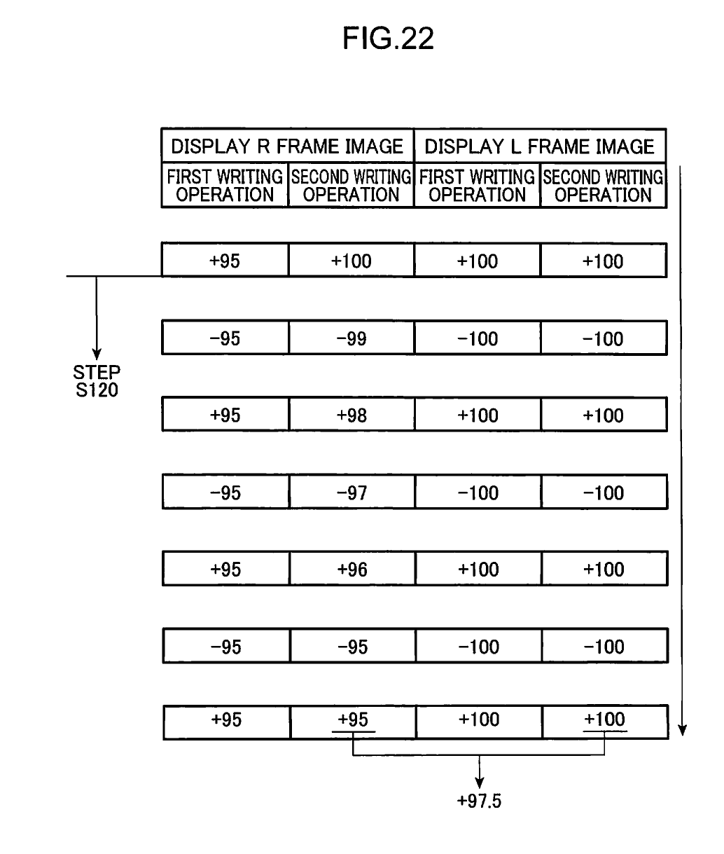

FIG. 22 is a schematic chart showing resultant luminance change from the execution of the step S120. The change in luminance of the liquid crystal panel 231 is described with reference to FIGS. 7, 11, 17 to 19, 21 and 22.

As shown in FIG. 22, the gamma adjuster 213B performs the signal processes, which are described with reference to FIG. 11 or 17, only for the R signal to generate the second image data, so that the absolute value of the luminance corresponding to the second writing operation for the R frame image is gradually decreased. FIG. 22 shows that the execution of the step S120 continues until the luminance for the R frame image reaches “±95”.

The viewer perceives the luminance at the end of the second writing operation. Thus, as a result of the execution of the step S120, the viewer perceives a luminance of “97.5” for the set of the frame images including the R and L frame images. Therefore, it becomes less likely that the viewer perceives the resultant luminance change from the halt of the second writing operation.

### Fourth Embodiment

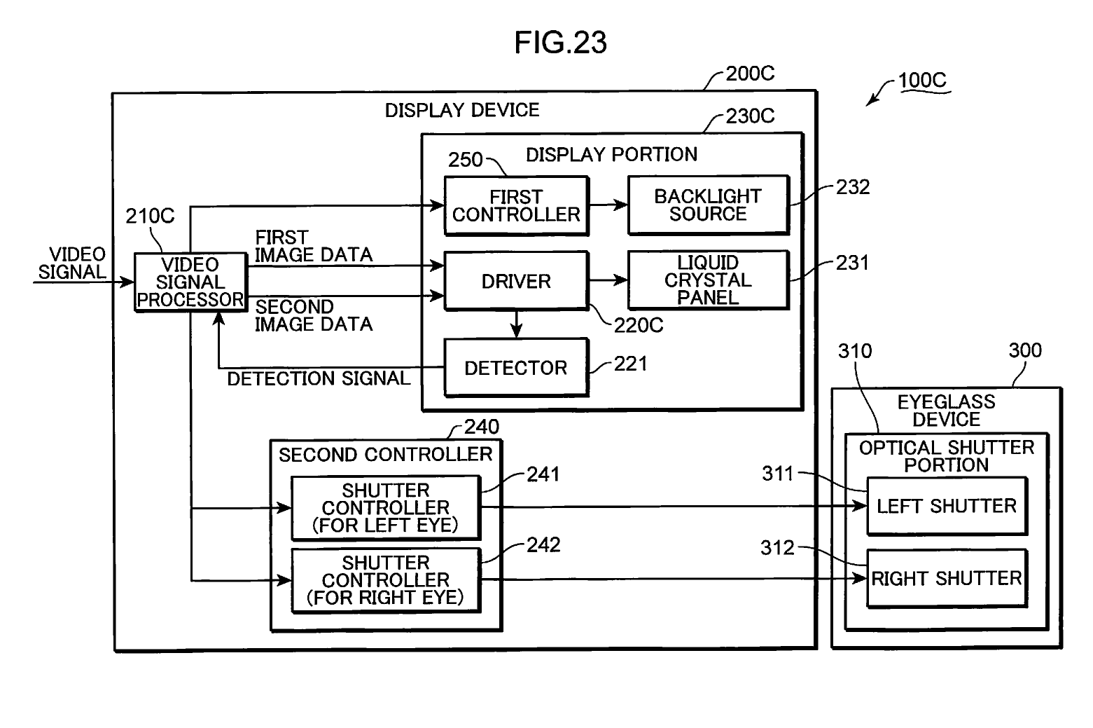

FIG. 23 is a schematic block diagram showing a configuration of a video system including a display device according to the fourth embodiment. The schematic configuration of the video system is described with reference to FIG. 23. It should be noted that any elements similar to those described in the context of the first embodiment are depicted by similar reference numerals. The following descriptions mainly directs to differences from the first embodiment. The descriptions in the first embodiment are incorporated by reference for similar features to the first embodiment.

### (Configuration of Video System)

The video system 100C comprises a display device 200C, in addition to the eyeglass device 300 which is described in the context of the first embodiment. The display device 200C has a display portion 230C and a video signal processor 210C, in addition to the second controller 240 which is described in the context of the first embodiment. The display portion comprises a driver 220C, in addition to the first controller 250, the backlight source 232, the liquid crystal panel 231 and the detector 221, which are described in the context of the first embodiment. The driver 220C is different from the driver 220 in the first embodiment because the driver 220C performs the first writing operation faster than the second writing operation.

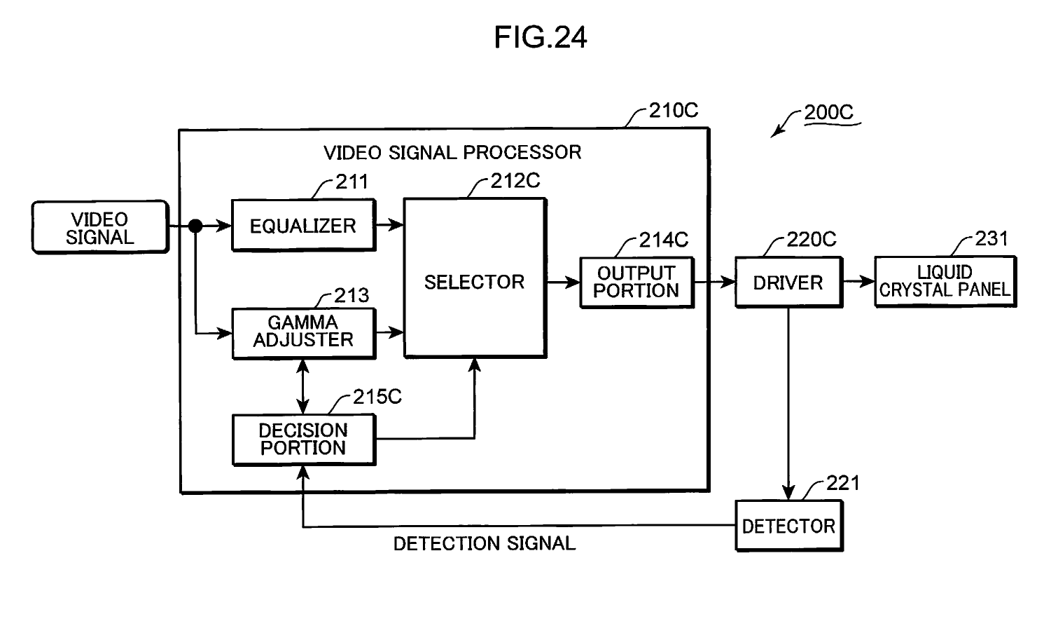

FIG. 24 is a schematic block diagram showing a functional configuration of the video signal processor 210C of the display device 200C. The video signal processor 210C is described with reference to FIGS. 23 and 24.

The video signal processor 210C has an output portion 214C, a decision portion 215C, a selector 212C and an equalizer 211, in addition to the gamma adjuster 213 which is described in the context of the first embodiment. The equalizer 211 processes signals to decrease resolution of the first image data. It may take a shorter time for the driver 220C to write the first image data than the second image data under the reduction in the resolution of the first image data. In this embodiment, the equalizer 211 is exemplified as the resolution adjuster. The equalizer 211 performs an equalization operation (an averaging operation or a selecting operation) on the video signal as described below.

### (Equalization Operation (Averaging Operation))

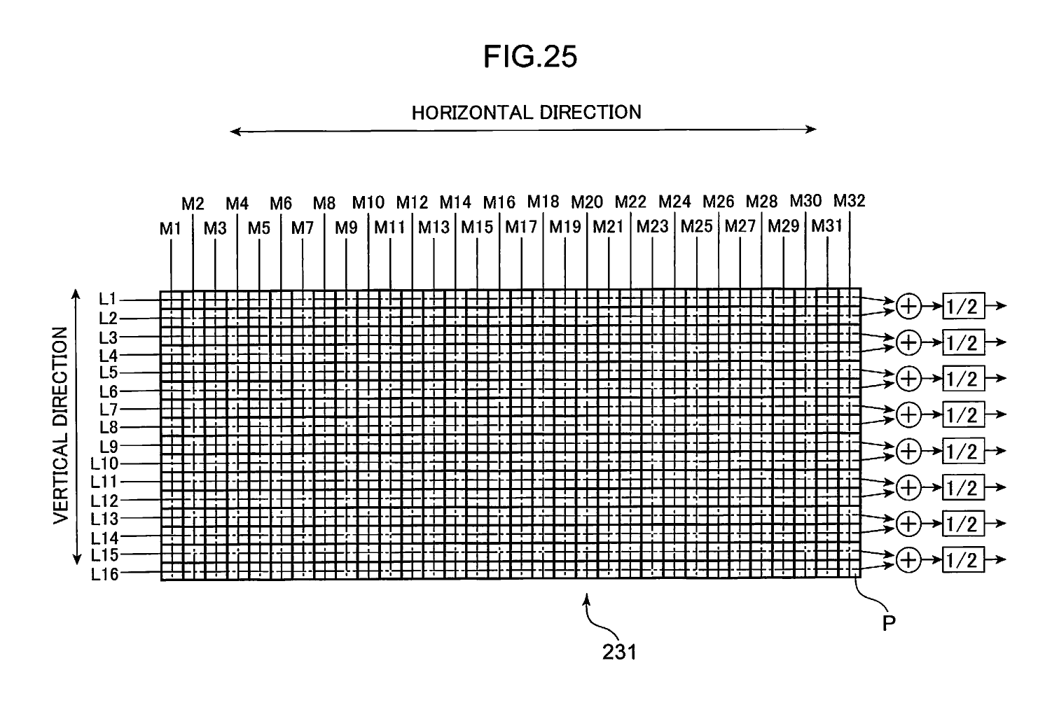

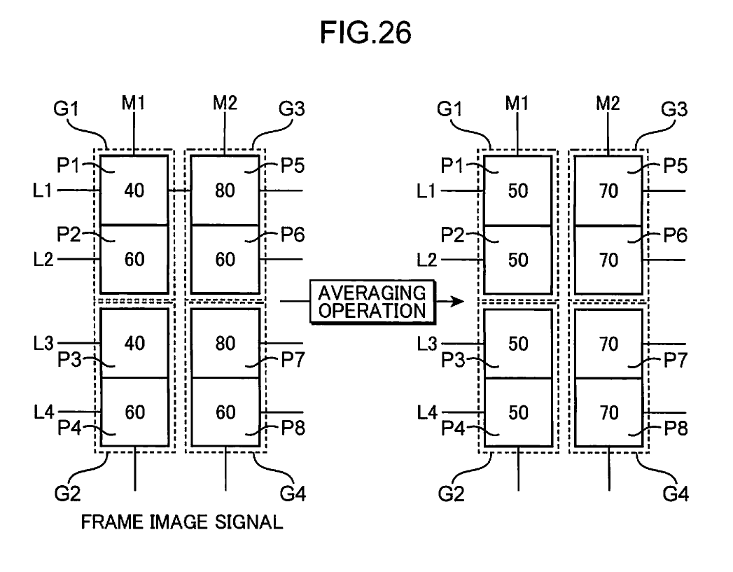

FIG. 25 is a schematic view of a part of the liquid crystal panel 231. FIG. 26 shows change in luminance of a pixel defined by the averaging operation, which is exemplified as the equalization operation. The averaging operation is described with reference to FIGS. 23 to 26.

The liquid crystal panel 231 has a number of the gate lines, which horizontally extend, and a number of the data lines, which vertically extend. FIG. 25 shows the gate lines L₁ to L₁₆, which are vertically aligned, and data lines M₁ to M₃₂, which are horizontally aligned. Pixels P and liquid crystals (not shown) corresponding to the pixels P are situated at the intersections between the gate lines L₁ to L₁₆ and the data lines M₁ to M₃₂. A driving amount of the liquid crystal is determined by the voltage applied to the gate lines L₁ to L₁₆ and the data lines M₁ to M₃₂.

FIG. 26 shows the pixels P1 to P8 at the intersections between the gate lines L₁ to L₄ and the data lines M₁ and M₂. As shown in FIG. 24, the equalizer 211 directly receives the frame video signals (the L and R frame image signals). The equalizer 211 defines a pixel group (a set of pixels enclosed by the dotted line in FIG. 26), which includes a number of pixels which are vertically aligned. FIG. 26 shows the pixel group G1, which includes a set of the pixels P1, P2 aligned on the data line M₁, the pixel group G2, which includes a set of the pixels P3, P4 aligned on the data line M₁, the pixel group G3, which includes a set of the pixels P5, P6 aligned on the data line M₂, and the pixel group G4, which includes a set of the pixels P7, P8 aligned on the data line M₂.

The numeric values shown in the pixels in FIG. 26 represent luminance assigned to the corresponding pixels. For example, the frame image signal defines luminance of “40” for the pixels P1, P3, luminance of “60” for the pixels P2, P4, P6, P8, and luminance of “80” for the pixels P5, P7. The equalizer 211 averages the luminance in each of the pixel groups G1, G2, G3, G4. The equalizer 211 averages the luminance of “40” and the luminance of “60” defined for the pixels P1, P2, respectively, in the pixel group G1 to determine luminance of “50” for the pixels P1, P2. The equalizer 211 averages the luminance of “40” and the luminance of “60” defined for the pixels P3, P4, respectively, in the pixel group G2 to determine luminance of “50” for the pixels P3, P4. The equalizer 211 averages the luminance of “80” and the luminance of “60” defined for the pixels P5, P6, respectively, in the pixel group G3 to determine luminance of “70” for the pixels P5, P6. The equalizer 211 averages the luminance of “80” and the luminance of “60” defined for the pixels P7, P8, respectively, in the pixel group G4 to determine luminance of “70” for the pixels P7, P8. As shown in FIG. 25, the aforementioned averaging operation is performed for all pixels P corresponding to the intersections between the gate lines L₁ to L₁₆ and the data lines M₁ to M₃₂.

### (Equalization Operation (Selecting Operation))

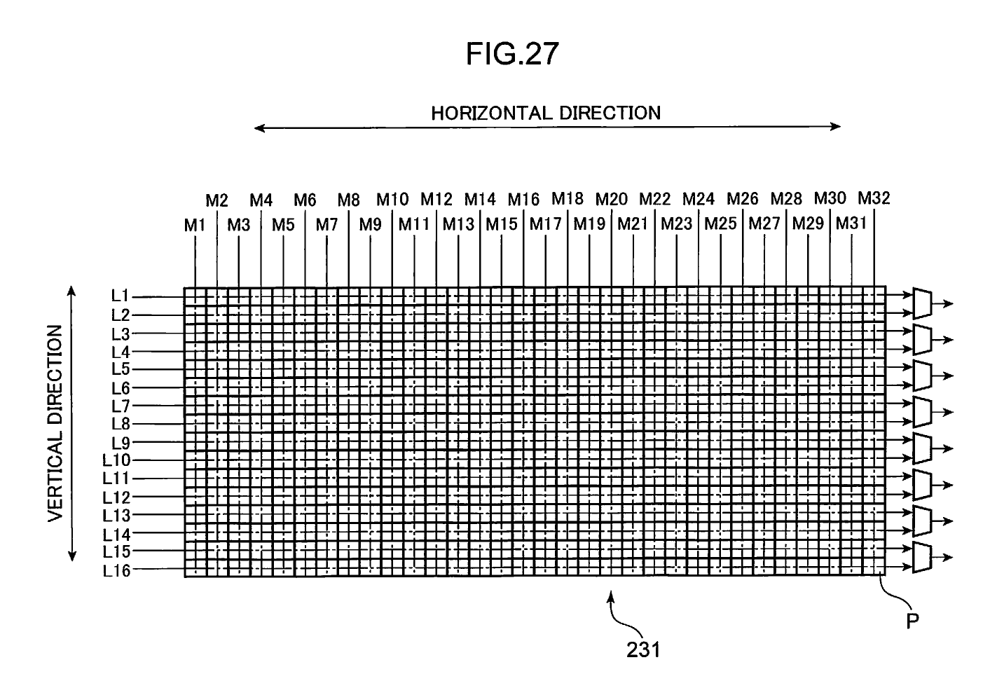

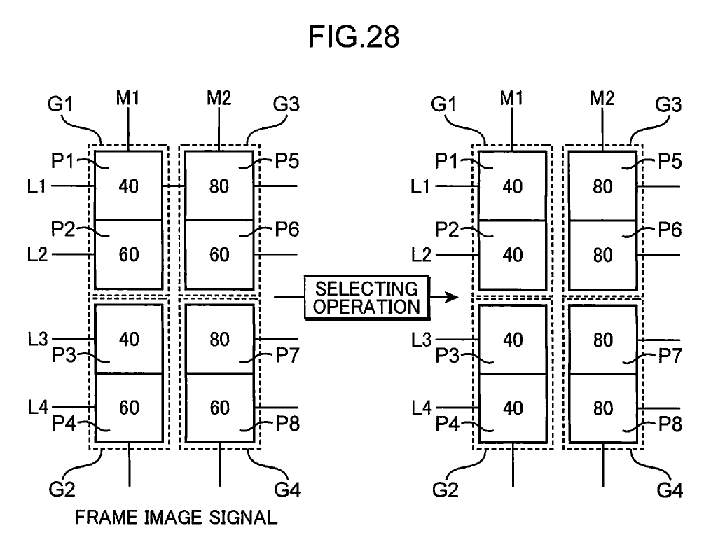

FIG. 27 is a schematic view of a part of the liquid crystal panel 231. FIG. 28 shows change in luminance of a pixel defined by the selecting operation, which is exemplified as the equalization operation. The selecting operation is described with reference to FIGS. 23, 24, 27 and 28.

The liquid crystal panel 231 includes a number of the gate lines, which horizontally extend, and a number of data lines, which vertically extend. FIG. 27 shows the gate lines L₁ to L₁₆, which are vertically aligned, and the data lines M₁ to M₃₂, which are horizontally aligned. Pixels P and liquid crystals (not shown) corresponding to the pixels P are situated at the intersections between the gate lines L₁ to L₁₆ and the data lines M₁ to M₃₂. A driving amount of the liquid crystal depends on the voltage applied to the gate lines L₁ to L₁₆ and the data lines M₁ to M₃₂.

FIG. 28 shows the pixels P1 to P8 which correspond to the intersections between the gate lines L₁ to L₄ and the data lines M₁ and M₂. The equalizer 211 defines a pixel group (a set of pixels enclosed in the dotted line in FIG. 28) which includes a number of pixels that are vertically aligned. FIG. 28 shows the pixel group G1, which includes a set of the pixels P1, P2 aligned on the data line M₁, the pixel group G2, which includes a set of the pixels P3, P4 aligned on the data line M₁, the pixel group G3, which includes a set of the pixels P5, P6 aligned on the data line M₂, and the pixel group G4, which includes a set of the pixels P7, P8 aligned on the data line M₂.

The numeric values shown in the pixels P1 to P8 in FIG. 28 represent luminance assigned to the corresponding pixels P1 to P8. For example, the frame image signal defines luminance of “40” for the pixels P1, P3, luminance of “60” for the pixels P2, P4, P6, P8, and luminance of “80” for the pixels P5, P7. The equalizer 211 selects the luminance in each of the pixel groups G1, G2, G3, G4. The equalizer 211 selects the luminance defined for the pixels P1, P3, P5, P7 on the odd-numbered gate lines and assigns the selected luminance to the other pixels P2, P4, P6, P8, respectively, in the pixel groups G1, G2, G3, G4. Thus, the pixels P1, P2 in the pixel group G1 and the pixels P3, P4 in the pixel group G2 have the luminance of “40”. The pixels P5, P6 in the pixel group G3 and the pixels P7, P8 in the pixel group G4 have the luminance of “80”. Alternatively, the equalizer 211 may select higher or lower luminance defined for the pixels in the pixel group by the frame image signal. Yet alternatively, the equalizer 211 may select luminance to generate the first image data by means of other suitable methodologies. The aforementioned selecting operation is performed for all pixels P at the intersections between the gate lines L₁ to L₁₆ and the data lines M₁ to M₃₂ as shown in FIG. 27.

### (First and Second Writing Operations)

The first and second writing operations for writing the first and second image data, respectively, are described below.

The equalizer 211 performs the aforementioned averaging operation on the frame image signal to output an average signal. Alternatively, the equalizer 211 performs the aforementioned selecting operation on the frame image signal to output a selection signal.

The average or selection signal is output to the selector 212C as shown in FIG. 24, so that the selector 212C receives the signal processed by the equalizer 211 as a signal used for generating the first image data and receives the signal processed by the gamma adjuster 213 as a signal used for generating the second image data. The selector 212C outputs the signal processed by the equalizer 211 to the output portion 214C while the first image data are written. The selector 212C outputs the signal processed by the gamma adjuster 213 to the output portion 214C while the second image data are written.

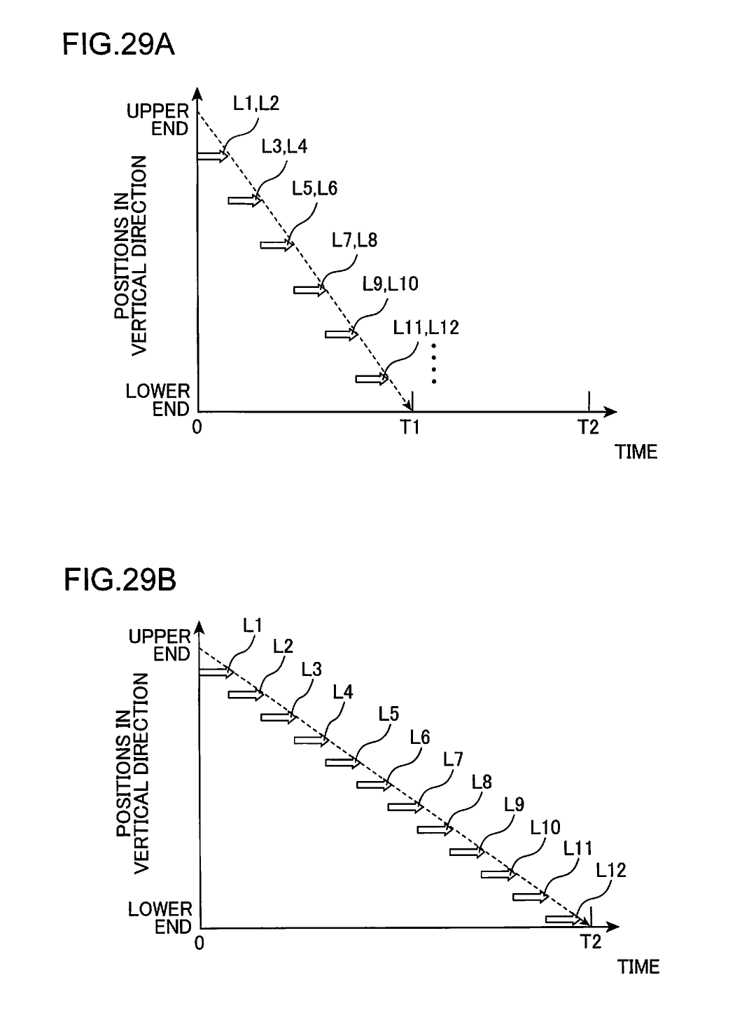

FIGS. 29A and 29B are graphs schematically showing writing operations performed by the driver 220C. FIG. 29A shows the first writing operation for writing the first image data. FIG. 29B shows the second writing operation for writing the second image data. FIGS. 29A and 29B show the writing operations for the gate lines L₁ to L₁₂. The abscissa in FIGS. 29A and 29B is a time axis during which the writing operations are performed for the gate lines L₁ to L₁₂. The ordinate in FIGS. 29A and 29B indicates vertical positions in the liquid crystal panel 231. The first and second writing operations are described with reference to FIGS. 23, 24, 26, 28 to 29B.

The equalizer 211 defines identical luminance for the pixels in the pixel groups G1, G2, G3, G4, respectively, which include the pixels that are vertically aligned, as described with reference to FIGS. 26 and 28. Thus, the driver 220C may simultaneously write the first image data on the gate lines L₂ₜ₋₁, L₂ₜ (t is a natural number). As a result, the liquid crystals corresponding to the pixels on the gate lines L₂ₜ₋₁, L₂ₜ (t is a natural number) are simultaneously driven.

Since the second image data are generated in response to the video signal processed by the gamma adjuster 213, luminance is potentially different from pixel to pixel. Thus, the driver 220C sequentially writes the second image data from the gate lines L₁ to the lowermost gate line.

The driver 220C performing the first writing operation simultaneously writes the first image data on the set of the two gate lines L₂ₜ₋₁, L₂ₜ, so that the period T1 required for completing the first writing operation on the gate line L₁₂ becomes half the period T2 required for completing the second writing operation on the gate line L₁₂ in this embodiment. Due to the relatively quick first writing operation, it becomes earlier to start driving the liquid crystal of the liquid crystal panel 231 over the entire display surface. Therefore, there is a decreased crosstalk, in particular, in a lower portion of the display surface.

### (Display Control Method for Decreasing Writing Frequency)

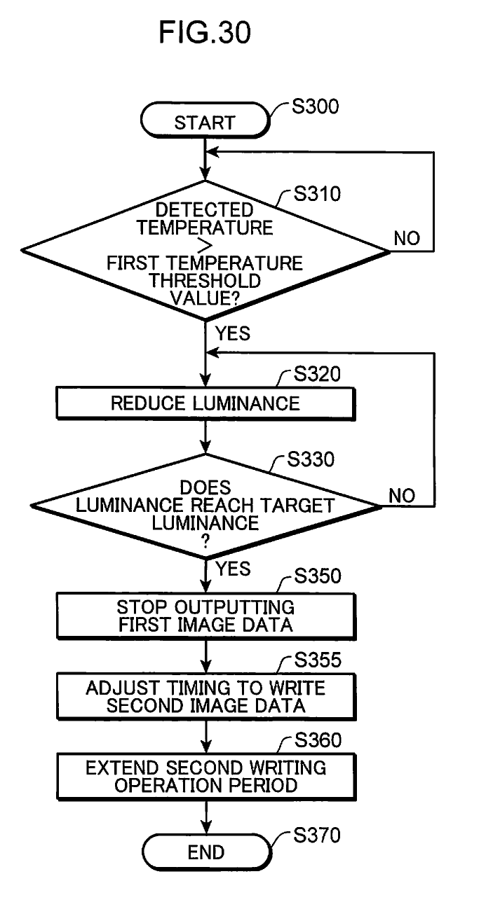

FIG. 30 is a schematic flow chart showing a display control method when the detector 221 detects a higher temperature of the driver 220C than the first temperature threshold value. The display control method is described with reference to FIGS. 11, 17, 23, 24, 29A to 30.

### (Step S300)

The detector 221 measures the temperature of the driver 220C to output the detection signal including information about the measured temperature to the decision portion 215C as shown in FIG. 24. The driver 220C writes the first and second image data to the liquid crystal panel 231. It should be noted that it takes shorter to write the first image data to the liquid crystal panel 231 than the second image data, as described with reference to FIGS. 29A and 29B. In this embodiment, the step S300 is exemplified as the step of measuring the temperature of the driver.

### (Step S310)

The decision portion 215C determines whether or not the temperature of the driver 220C is higher than the first temperature threshold value in the step S310. Unless the temperature of the driver 220C is higher than the first temperature threshold value, the step S310 is repeated. While the step S310 is repeated, the driver 220C writes the first and second image data to the liquid crystal panel 231. If the temperature of the driver 220C exceeds the first temperature threshold value, the step S320 is performed. It depends on the decision at the step S310 whether the writing operation is performed twice or one time. Thus, in this embodiment, the step S310 is exemplified as the step of determining how many times the image data are written.

### (Step S320)

In the step S320, the gamma adjuster 213 adjusts the gamma value to reduce the luminance level of the second image data. The step S330 is then performed. It should be noted that, in this embodiment, the luminance adjustment performed by the gamma adjuster 213 is similar to the first or second embodiment.

### (Step S330)

In the step S330, the decision portion 215C determines whether or not the luminance level reaches a target luminance level. Unless the luminance level reaches the target luminance level, the step S320 is performed again to further reduce the luminance level. After the output characteristics of the gamma adjuster 213, which are described with reference to FIG. 11 or 17, are changed to the extent that the viewer perceives few resultant luminance changes from the decrease in the number of the writing operations, the gamma adjuster 213 outputs the notification signal to the decision portion 215C. If the decision portion 215C receives the notification signal output from the gamma adjuster 213, the step S350 is performed.

### (Step S350)

The decision portion 215C outputs a control signal to make the selector 212C stop outputting the first image data in the step S350. If the selector 212C stops outputting the first image data, the step S355 is performed.

### (Step S355)

The selector 212C outputs the second image data, instead of the first image data, to the output portion 214C in the step S355 so as to adjust the writing timing of the second image data. The adjustment of the writing timing is described later.

### (Step S360)

In the step S360, the driver 220C may gradually extend the writing period for the second image data. After a predetermined number of frame images are displayed on the liquid crystal panel 231 in the step S355 or if the temperature drop of the driver 220C is insufficient, the step S360 may be performed.

### (Step S370)

The step S370 is performed if the writing period for the second image data becomes sufficiently long in the step S360 or after the step S355 is performed. In the step S370, the driver 220 writes only the second image data to the liquid crystal panel 231. The step S370 and the aforementioned step S300 are processes to write the image data by the number of times determined on the basis of the decision result in the step S310 to display the frame image on the liquid crystal panel 231. Thus, the steps S370 and S300 are exemplified as the step of displaying the frame image on the liquid crystal panel.

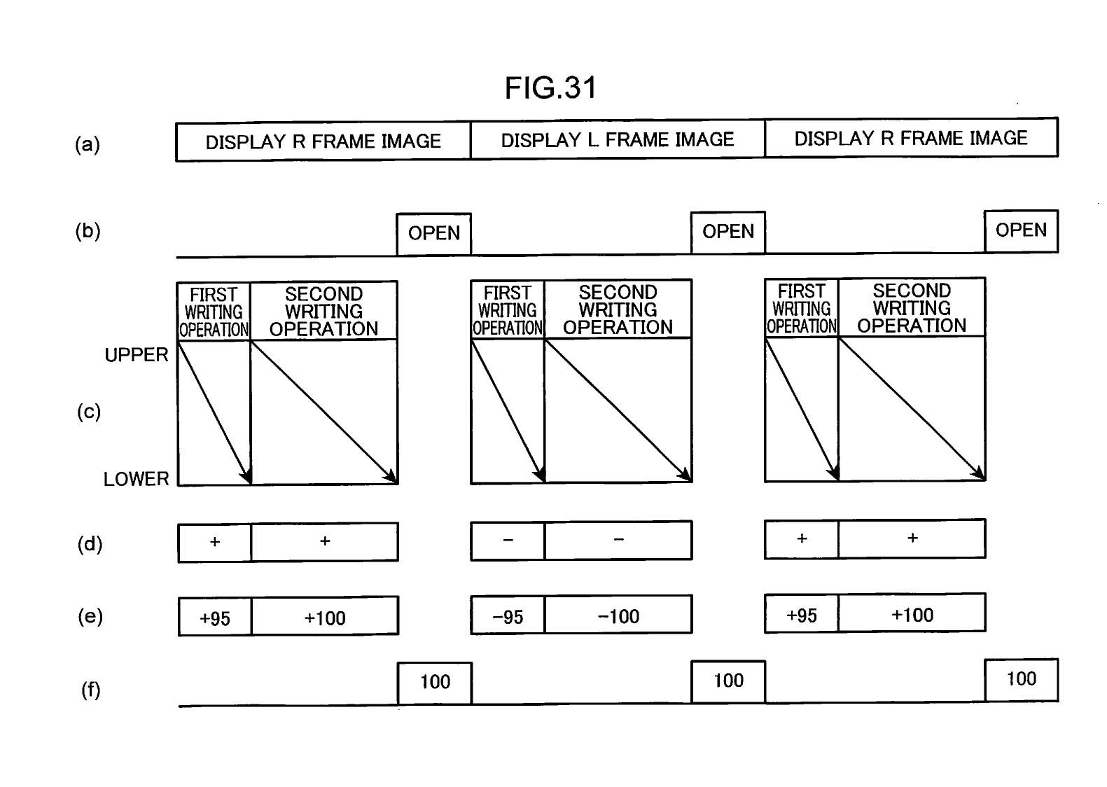

FIG. 31 is a schematic timing chart showing an operation of the video system 100C in the aforementioned step S300 with reference to FIG. 30. The operation of the video system 100C in the step S300 is described with reference to FIGS. 23, 24, 30 and 31.

The section (a) in FIG. 31 shows displayed frame images. As shown by the section (a) in FIG. 31, the liquid crystal panel 231 alternately displays the R and L frame images.

In order to clearly describe the principle of the luminance adjustment, in the descriptions with reference to FIG. 31, the video system 100C displays white video images for both of the R and L frame images.

The section (c) in FIG. 31 schematically shows an operation of the driver 220C to write image data to the liquid crystal panel 231. As described above, in order to display the R or L frame image, the driver 220 performs the first writing operation (writing the first image data) and the second writing operation (writing the second image data). The writing operation begins at an upper area of the liquid crystal panel 231 and ends at a lower area thereof. The first writing operation is performed faster than the second writing operation.

The section (b) in FIG. 31 shows an operation of the optical shutter portion 310. The optical shutter portion 310 opens the right or left shutter 312, 311 at the end of the writing period for the R or L frame image (a period between the end of the second writing operation and the beginning of the display period for the subsequent frame image). While the right shutter 312 is kept open, the viewer views the R frame image. While the left shutter 311 is kept open, the viewer views the L frame image.

The section (d) in FIG. 31 shows polarities of a voltage applied while the first and second writing operations are performed. A voltage of the positive polarity is applied during the display of the R frame image. A voltage of the negative polarity is applied during the display of the L frame image. As a result, it becomes easier to keep a medium potential. One of the positive and negative polarities is exemplified as the first polarity while the other is exemplified as the second polarity in this embodiment.

The section (e) in FIG. 31 shows a potential charged in a pixel. The section (e) in FIG. 31 contains numeric values such as “+95”, “+100”, “−95” and “−100”. The symbols “+” and “−” mean the polarity of the voltage described with reference to the section (d) in FIG. 31. The numeric values such as “+95”, “+100”, “−95” and “−100” mean a charging potential of the pixel. In the descriptions with reference to the section (e) in FIG. 31, the numeric value “±100” means a potential for representing “white”. The numeric value “±95” means a darker hue than “white” (e.g., gray).

As shown in the section (e) in FIG. 31, the period of the first writing operation is short, so that the charging potential does not reach the target value of “+100” in the initial display of the R frame image. The charging potential reaches the value of “+100” in the subsequent second writing operation.

The driver 220 changes the polarity of the applied voltage from “positive” to “negative” to display the subsequent L frame image. It is required to change the charging potential from “+100” to “−100” in order to display the white L frame image like the R frame image, but the period of the first writing operation to display the L frame image is too short to vary the charging potential in this range. As a result, the charging potential has a value of “−95” at the end of the first writing operation performed for displaying the L frame image. The charging potential reaches a value of “−100” in the subsequent second writing operation.

The section (f) in FIG. 31 shows luminance perceived by the viewer through the eyeglass device 300. The numeric value “100” shown in the section (f) in FIG. 31 means that a “white” frame image is viewed. It should be noted that numeric values which is no more than “100” mean darker hues than “white” (e.g., gray).

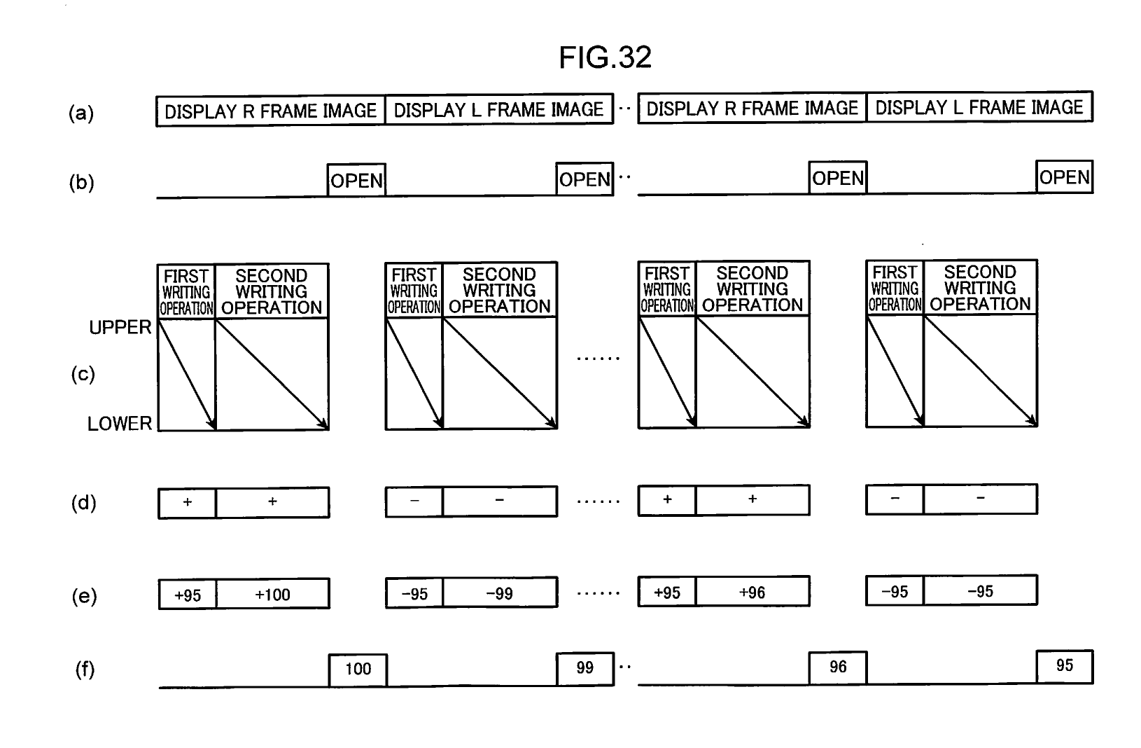

FIG. 32 is a schematic timing chart showing an operation of the video system 100C in the step S320, which is described with reference to FIG. 30. The operation of the video system 100C in the step S320 is described with reference to FIGS. 11, 17, 23, 24, 30 to 32.

The sections (a) to (d) and the section (f) in FIG. 32 correspond to the sections (a) to (d) and the section (f) in FIG. 31, respectively.

It may be figured out that the charging potential achieved in the second writing operation is gradually reduced, with comparing the section (e) in FIG. 32 to the section (e) in FIG. 31. The gamma adjuster 213 changes its output characteristics once the step S320 starts decreasing the charging potential as described with reference to FIGS. 11 and 17. Thus, the subsequent L and R frame images have a lower luminance level than the preceding L and R frame images, which results in gradually decreased luminance of the frame image which the viewer perceives.

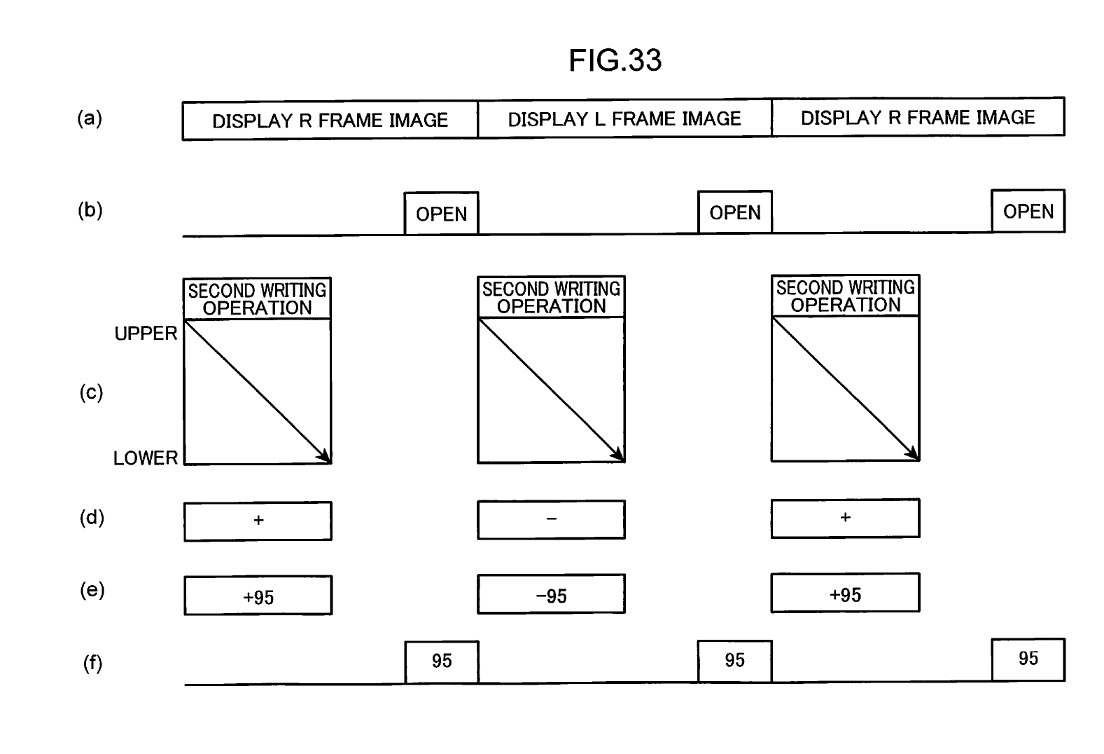

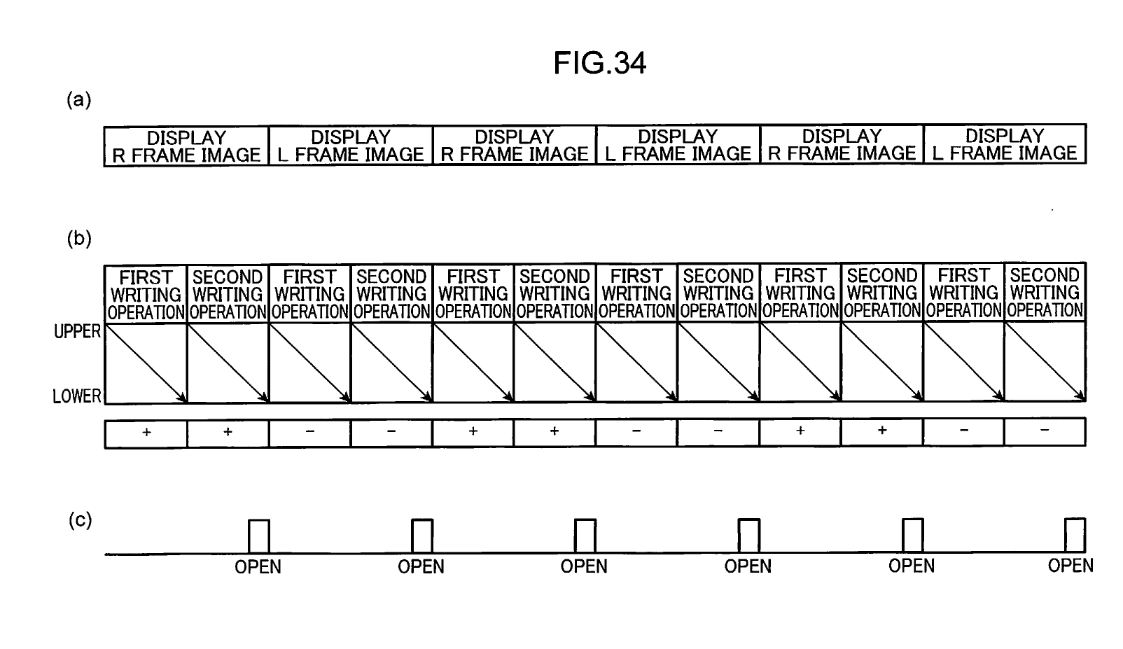

FIG. 33 is a schematic timing chart showing an operation of the video system 100C from the steps S350 to S355 which are described with reference to FIG. 31. The operation of the video system 100C from the steps S350 to S355 is described with reference to FIGS. 23, 24, 30, 31 and 33.

The sections (a), (b), (d) to (f) in FIG. 33 correspond to the sections (a), (b), (d) to (f) in FIG. 31, respectively.

As described with reference to FIG. 30, in the step S350, the selector 212C stops outputting the signal used as the first image data. In the step S355, the selector 212C adjusts the timing to output the signal used as the second image data. As a result, the signal used as the second image data is output in synchronization with the beginning of the R or L frame image.

The section (c) in FIG. 33 shows a writing operation for the second image data performed by the driver 220C in the step S370. The second writing operation for writing the second image data is started in synchronization with the beginning of the display period for the R and L frame images after the operations in the steps S350 and S355 as shown in the section (c) of FIG. 33. As a result of the luminance reduction in the step S320, it becomes less likely that the viewer perceive the resultant luminance change from the operations in the steps S350 and S355.

### (Display Control Method for Increasing Writing Frequency)

The decision portion 215C determines whether or not the temperature of the driver 220C is lower than the second temperature threshold value, like the first embodiment. If the temperature of the driver 220C is lower than the second temperature threshold value, the number of writing operations is increased by the inverse processes to those shown in FIG. 30.

The principle in this embodiment is achieved by means of various electronic elements. For example, the aforementioned series of the control may be executed by means of an integrated circuit and a program built therein.

The above various embodiments are merely illustrative. Accordingly, the principle of the aforementioned embodiments is not limited to the aforementioned detailed descriptions and the accompanying drawings. It may be easily understood that those skilled in the art may make various modifications, combinations and omission within the principle of the above embodiments.

The above embodiments mainly include the display device and the video view system with the following configurations.

A display device according to one aspect of the above embodiments has a liquid crystal panel including liquid crystals which are driven to display a frame image; a generator which generates image data to display the frame image in response to a frame image signal corresponding to the frame image; a driver which writes the image data to the liquid crystal panel to drive the liquid crystals; and a detector configured to detect a temperature of the driver, wherein the generator adjusts how many times the image data are written to the liquid crystal panel by the driver in response to the temperature of the driver.

According to the above configuration, the generator generates the image data to display the frame image in response to the frame image signal corresponding to the frame image. The driver writes the image data to the liquid crystal panel to drive the liquid crystals, so that the liquid crystal panel displays the frame image.

The detector detects the temperature of the driver. The generator adjusts how many times the image data are written to the liquid crystal panel by the driver, in response to the temperature of the driver. Therefore, it becomes less likely that there is an excessive temperature rise of the driver. Thus, it becomes less likely that heat generated from the driver deteriorates the frame image.

In the aforementioned configuration, it is preferable that the frame image includes a first frame image and a second frame image which is displayed after the first frame image, the generator includes a luminance adjuster which processes the frame image signal to generate the image data and adjust a luminance level of the frame image displayed on the liquid crystal panel, and if the temperature of the driver is higher than a first threshold value defined for the temperature of the driver, the luminance adjuster sets the luminance level of the second frame image to a second luminance level which is lower than a first luminance level defined for the first frame image.

According to the above configuration, the luminance adjuster processes the frame image signal to generate the image data and adjust the luminance level of the frame image displayed on the liquid crystal panel. The luminance adjuster sets the luminance level of the second frame image displayed after the first frame image to the second luminance level, which is lower than the first luminance level defined for the first frame image if the temperature of the driver is higher than the first threshold value defined for the temperature of the driver. Thus, the luminance level of the frame image is sequentially reduced if the temperature of the driver is higher than the first threshold value defined for the temperature of the driver.

In the aforementioned configuration, it is preferable that the image data include first image data and second image data which are written to the liquid crystal panel subsequent to the first image data, and the luminance adjuster sets the luminance level for the first image data to the first luminance level to display the first frame image, and sets the luminance level for the second image data to the second luminance level to display the second frame image.

According to the above configuration, the image data include the first image data and the second image data which are written to the liquid crystal panel subsequent to the first image data. The luminance adjuster sets the luminance level for the first image data to the first luminance level to display the first frame image. The luminance adjuster sets the luminance level for the second image data to the second luminance level to display the second frame image. Therefore, if the temperature of the driver is higher than the first threshold value defined for the temperature of the driver, the luminance level of the frame image is sequentially reduced.

In the above configuration, it is preferable that if the luminance level for the second image data is reduced to a target level defined for the luminance level, the generator stops outputting the second image data so that the driver drives the liquid crystals in response to the first image data to display the frame image on the liquid crystal panel.

According to the above configuration, the generator stops outputting the second image data if the luminance level for the second image data is reduced to the target level defined for that luminance level. As described above, if the temperature of the driver is higher than the first threshold value defined for the temperature of the driver, the luminance level of the frame image is sequentially reduced. Therefore, the viewer views the frame image displayed on the liquid crystal panel without perceiving the output halt of the second image data even if the driver drives the liquid crystals in response to the first image data. The driver less frequently writes the image data, which results in a rapid temperature drop of the driver.

In the aforementioned configuration, it is preferable that the liquid crystal panel includes gate lines to which the image data are written; the driver writes the second image data in less gate lines than the gate lines, to which the image data are written before the luminance level for the second image data reaches a target level defined for the luminance level, after the luminance level for the second image data is reduced to the target level and before the generator stops outputting the second image data.

According to the above configuration, the driver writes the second image data to less gate lines than the gate lines, to which the image data are written before the luminance level for the second image data reaches the target level defined for the luminance level, after the luminance level for the second image data is reduced to the target level and before the generator stops outputting the second image data. As a result, it becomes likely that the viewer views the frame image displayed on the liquid crystal panel without perceiving the output halt of the second image data even if the driver drives the liquid crystals in response to the first image data.

In the aforementioned configuration, it is preferable that the driver writes the first image data in a first time length if the generator outputs the first and second image data, and the driver writes the first image data in a second time length which is longer than the first time length if the generator stops outputting the second image data.

According to the above configuration, the driver writes the first image data in the first time length if the generator outputs the first and second image data. The driver writes the first image data in the longer second time length than the first time length if the generator stops outputting the second image data. Consequently, it becomes less likely that the first image data are insufficiently written.

In the aforementioned configuration, it is preferable that the frame image includes a left frame image, which is viewed by a left eye, and a right frame image, which is viewed by a right eye, the liquid crystal panel alternately displays the left and right frame images, the driver, which drives the liquid crystals in a frame inversion mode, drives the liquid crystals with a first polarity to display the left frame image on the liquid crystal panel, and drives the liquid crystals with a second polarity opposite to the first polarity to display the right frame image on the liquid crystal panel, and the luminance adjuster sets the luminance level of the second image data for the left and right frame images to the second luminance level, respectively.

According to the above configuration, the liquid crystal panel alternately displays the left frame image, which is viewed by the left eye, and the right frame image, which is viewed by the right eye. The driver, which drives the liquid crystals in the frame inversion mode, drives the liquid crystals with the first polarity to display the left frame image on the liquid crystal panel. The driver drives the liquid crystals with the second polarity opposite to the first polarity to display the right frame image on the liquid crystal panel. The luminance adjuster sets the luminance level of the second image data for the left and right frame images to the second luminance level, respectively. Thus, if the temperature of the driver is higher than the first threshold value defined for the temperature of the driver, the luminance level of the frame image is sequentially reduced.

In the above configuration, it is preferable that the frame image includes a first set of frame images including a left frame image, which is viewed by the left eye, and a right frame image, which is different in contents by parallax and viewed by a right eye, and a second set of frame images which include the left and right frame images displayed subsequent to the first set of the frame images, the liquid crystal panel alternately displays the left and right frame images, the driver, which drives the liquid crystals in a frame inversion mode, drives the liquid crystals with a first polarity to display the first set of the frame images, and drives the liquid crystals with a second polarity opposite to the first polarity to display the second set of the frame images, and the luminance adjuster sets the luminance level for the second image data corresponding to one of the left and right frame images to the second luminance level.

According to the above configuration, the frame image have a first set of frame images including a left frame image, which is viewed by the left eye, and a right frame image, which is different in contents by parallax and viewed by a right eye, and a second set of frame images which include the left and right frame images displayed subsequent to the first set of the frame images. The liquid crystal panel alternately displays the left and right frame images. The driver, which drives the liquid crystals in a frame inversion mode, drives the liquid crystals with the first polarity to display the first set of the frame images. The driver drives the liquid crystals with the second polarity opposite to the first polarity to display the second set of the frame images. The luminance adjuster sets the luminance level for the second image data corresponding to one of the left and right frame images to the second luminance level. Therefore, the luminance level of the frame image is sequentially reduced if the temperature of the driver is higher than the first threshold value defined for the temperature of the driver.

In the aforementioned configuration, it is preferable that the second luminance level defined for the second set of the frame images is lower than the second luminance level defined for the first set of the frame images.

According to the above configuration, the second luminance level defined for the second set of frame images is lower than the second luminance level defined for the first set of frame images. Therefore, the luminance level of the frame image is sequentially reduced if the temperature of the driver is higher than the first threshold value defined for the temperature of the driver.

In the above configuration, it is preferable that the frame image signal includes a gradation signal which defines luminance of pixels corresponding to the liquid crystals, and the luminance adjuster, which performs gamma correction on the gradation signal to generate the image data, adjusts a gamma value for a gradation region, which is larger than a predetermined gradation value among gradation regions defined by the gradation signal, to generate the second image data.

According to the above configuration, the luminance adjuster performs the gamma correction on the gradation signal which defines the luminance of the pixels corresponding to the liquid crystals to generate the image data. The luminance adjuster adjusts the gamma value for the gradation region which is larger than the predetermined gradation value among the gradation regions defined by the gradation signal to generate the second image data. Therefore, if a decrease in luminance level of the frame image is more likely to be perceived, the luminance of the gradation region is gradually reduced. As a result, it becomes less likely that a resultant change in image quality from a fluctuation in frequency of the writing operation of the image data is perceived.

In the aforementioned configuration, it is preferable that the frame image signal includes a gradation signal which defines luminance of pixels corresponding to the liquid crystals, and the luminance adjuster, which performs gamma correction on the gradation signal to generate the image data, adjusts a gamma value for an entire gradation region defined by the gradation signal to generate the second image data.

According to the above configuration, the luminance adjuster performs the gamma correction on the gradation signal which defines the luminance of the pixels corresponding to the liquid crystals to generate the image data. The luminance adjuster adjusts the gamma value for the entire gradation region defined by the gradation signal to generate the second image data, which may result in a simplified process to generate the second image data.

In the above configuration, the driver preferably writes the first image data faster than the second image data.

According to the aforementioned configuration, the driver writes the first image data faster than the second image data, which may result in less crosstalk in a region where the image data are written at a relatively late timing.

In the above configuration, the generator preferably includes a resolution adjuster which generates the first image data which have a lower resolution than the second image data.

According to the above configuration, the resolution adjuster generates the first image data, which have the lower resolution than the second image data, so that the first image data are written faster than the second image data, which may result in less crosstalk in a region where the image data are written at a relatively late timing.

In the aforementioned configuration, it is preferable that the generator restarts outputting the second image data, and the driver performs a first writing operation to drive the liquid crystals in response to the first image data and a second writing operation to drive the liquid crystals in response to the second image data if the temperature of the driver becomes lower than a second threshold value, which is lower than the first threshold value.

According to the above configuration, the generator starts outputting the second image data again if the temperature of the driver becomes lower than the second threshold value which is smaller than the first threshold value. The driver performs the first and second writing operations to drive the liquid crystals in response to the first and second image data, respectively. Thus, quality images are again displayed after the temperature drop of the driver.

A method for controlling display according to another aspect of the above embodiments comprises steps of: measuring a temperature of a driver which writes image data to a liquid crystal panel to drive liquid crystals; determining how many times the image data are written, in response to the temperature of the driver; and writing the image data by the determined number of times to display a frame image on the liquid crystal panel.

According to the above configuration, the temperature of the driver which writes the image data to the liquid crystal panel to drive the liquid crystals is measured. It is determined how many times the image data are written, in response to the temperature of the driver. The image data are written by the determined number of times to display the frame image on the liquid crystal panel. Therefore, it becomes less likely that the temperature of the driver excessively increases. Thus, it becomes less likely that heat generated from the driver deteriorate the frame image.

The principles of the aforementioned embodiments may be suitably applied to display devices and display systems in which two or more writing operations are performed to display a frame image.

This application is based on Japanese Patent application No. 2011-050642 filed in Japan Patent Office on Mar. 8, 2011, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A display device comprising:
a liquid crystal panel including liquid crystals which are driven to display a frame image;
a generator which generates image data to display the frame image in response to a frame image signal corresponding to the frame image;
a driver which writes the image data to the liquid crystal panel to drive the liquid crystals; and
a detector configured to detect a temperature of the driver, wherein
the generator adjusts how many times the image data are written to the liquid crystal panel by the driver in response to the temperature of the driver.

2. The display device according to claim 1, wherein
the frame image includes a first frame image and a second frame image which is displayed after the first frame image,
the generator includes a luminance adjuster which processes the frame image signal to generate the image data and adjust a luminance level of the frame image displayed on the liquid crystal panel, and
if the temperature of the driver is higher than a first threshold value defined for the temperature of the driver, the luminance adjuster sets the luminance level of the second frame image to a second luminance level which is lower than a first luminance level defined for the first frame image.

3. The display device according to claim 2, wherein
the image data include first image data and second image data which are written to the liquid crystal panel subsequent to the first image data, and
the luminance adjuster sets the luminance level for the first image data to the first luminance level to display the first frame image, and sets the luminance level for the second image data to the second luminance level to display the second frame image.

4. The display device according to claim 3, wherein
if the luminance level for the second image data is reduced to a target level defined for the luminance level, the generator stops outputting the second image data so that the driver drives the liquid crystals in response to the first image data to display the frame image on the liquid crystal panel.

5. The display device according to claim 4, wherein
the liquid crystal panel includes gate lines to which the image data are written;
the driver writes the second image data in less gate lines than the gate lines, to which the image data are written before the luminance level for the second image data reaches a target level defined for the luminance level, after the luminance level for the second image data is reduced to the target level and before the generator stops outputting the second image data.

6. The display device according to claim 4, wherein
the driver writes the first image data in a first length if the generator outputs the first and second image data, and
the driver writes the first image data in a second length which is longer than the first length if the generator stops outputting the second image data.

7. The display device according to claim 3, wherein
the frame image includes a left frame image, which is viewed by a left eye, and a right frame image, which is viewed by a right eye,
the liquid crystal panel alternately displays the left and right frame images,
the driver, which drives the liquid crystals in a frame inversion mode, drives the liquid crystals with a first polarity to display the left frame image on the liquid crystal panel, and drives the liquid crystals with a second polarity opposite to the first polarity to display the right frame image on the liquid crystal panel, and
the luminance adjuster sets the luminance level of the second image data for the left and right frame images to the second luminance level, respectively.

8. The display device according to claim 3, wherein
the frame image includes a first set of frame images including a left frame image, which is viewed by the left eye, and a right frame image, which is different in contents by parallax and viewed by a right eye, and a second set of frame images which include the left and right frame images displayed subsequent to the first set of the frame images,
the liquid crystal panel alternately displays the left and right frame images,
the driver, which drives the liquid crystals in a frame inversion mode, drives the liquid crystals with a first polarity to display the first set of the frame images, and drives the liquid crystals with a second polarity opposite to the first polarity to display the second set of the frame images, and
the luminance adjuster sets the luminance level for the second image data corresponding to one of the left and right frame images to the second luminance level.

9. The display device according to claim 8, wherein the second luminance level defined for the second set of the frame images is lower than the second luminance level defined for the first set of the frame images.

10. The display device according to claim 3, wherein
the frame image signal includes a gradation signal which defines luminance of pixels corresponding to the liquid crystals, and
the luminance adjuster, which performs gamma correction on the gradation signal to generate the image data, adjusts a gamma value for a gradation region, which is larger than a predetermined gradation value among gradation regions defined by the gradation signal, to generate the second image data.

11. The display device according to claim 3, wherein
the frame image signal includes a gradation signal which defines luminance of pixels corresponding to the liquid crystals, and
the luminance adjuster, which performs gamma correction on the gradation signal to generate the image data, adjusts a gamma value for an entire gradation region defined by the gradation signal to generate the second image data.

12. The display device according to claim 3, wherein the driver writes the first image data faster than the second image data.

13. The display device according to claim 12, wherein the generator includes a resolution adjuster configured to generate the first image data which have a lower resolution than the second image data.

14. The display device as claimed in claim 4, wherein
the generator restarts outputting the second image data, and the driver performs a first writing operation to drive the liquid crystals in response to the first image data and a second writing operation to drive the liquid crystals in response to the second image data if the temperature of the driver becomes lower than a second threshold value, which is lower than the first threshold value.

15. A method of controlling display, comprising:
measuring a temperature of a driver which writes image data to a liquid crystal panel to drive liquid crystals;
determining how many times the image data are written, in response to the temperature of the driver; and
writing the image data by the determined number of times to display a frame image on the liquid crystal panel.
